(19) United States
(12) Patent Application Publication
(10) Pub. No.: US 2025/0150667 A1
(43) Pub. Date: May 8, 2025

(54) MEDIA CHOREOGRAPHY SYSTEM

(71) Applicant: Spooler Media, Inc., Bend, OR (US)

(72) Inventors: Daniel Benjamin, Austin, TX (US); James O. Boggs, Bend, OR (US); Andrew Bowers, Santa Barbara, CA (US); Scott Simpson, Burlingame, CA (US)

(21) Appl. No.: 18/504,500

(22) Filed: Nov. 8, 2023

(51) Int. Cl. H04N 21/43; H04N 21/414; H04N 21/433

(52) U.S. Cl. CPC H04N 21/4307; H04N 21/41422; H04N 21/4331

(57) ABSTRACT

Provided is a method including receiving a request for a media choreography asset to play on a first client computing device that has control over at least one connected device that has a feature configured to provide a sensory output to a user; obtaining the media choreography asset that includes a primary media track that includes at least one content track to be presented via an audio or video system, and the media choreography asset includes one or more triggers that include a first set of instructions to operate a first set of the at least one connected device at a first timecode and a first duration during a playback of the primary media track; and providing the media choreography asset to the first client computing device.

### BACKGROUND

### 1. Field

The present disclosure relates generally to a computer-implemented system and method for media choreography.

### 2. Description of the Related Art

Internet distribution of media content, such as audio content, video content, visual content, audio video content, or other media content, continues to increase every year. For example, studies have reported a 500% increase in podcast consumption over the previous decade, with over 40% of the U.S. population reporting to have listened to a podcast in the past month. And numerous video streaming and local caching services have disrupted conventional cable, satellite, and movie businesses. Also, more and more people are receiving news and information from the Internet via their smartphones and computers. Even conventional conduits of media content, such as televisions, may receive media content through the Internet that is provided on-demand or stored locally in advance for the user.

### SUMMARY

The following is a non-exhaustive listing of some aspects of the present techniques. These and other aspects are described in the following disclosure.

Some aspects include a method including receiving, with a computer system and via a network, a request for a media choreography asset to play on a first client computing device that includes at least one of an audio system or a display system configured to output at least one of audio content or video content, respectively and the first client computing device has control over at least one connected device that has a feature that is configured to provide a sensory output to a user; obtaining, with the computer system, the media choreography asset, wherein the media choreography asset includes a primary media track that includes at least one of a first audio track to be presented via the audio system or a first video track to be presented via the display system, and the media choreography asset includes a one or more triggers that includes a first set of instructions to operate a first set of the at least one connected device at a first timecode and a first duration during a playback of the primary media track; and providing, with the computer system, the media choreography asset to the first client computing device, wherein the providing the media choreography asset to the first client computing device causes the primary media track to play via at least one the audio system or the display system and causes the first client computing device to operate the first set of the at least one connected device according to the first set of instructions at the first timecode in the primary media track.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a block diagram illustrating an example of a media choreography system, in accordance with some embodiments of the present disclosure;

FIG. 2 is a block diagram illustrating an example of a vehicle client computing device of the media choreography system of FIG. 1, in accordance with some embodiments of the present disclosure;

FIG. 3 is a block diagram illustrating a sensor system of the vehicle client computing device of FIG. 2, in accordance with some embodiments of the present disclosure;

FIG. 4 is a block diagram illustrating an example of a client computing device of the media choreography system of FIG. 1, in accordance with some embodiments of the present disclosure;

FIG. 5 is a block diagram illustrating an example of a content provider server computing device of the media choreography system of FIG. 1, in accordance with some embodiments of the present disclosure;

FIG. 6 is a flow diagram illustrating an example of a method of media choreography asset creation and publishing, in accordance with some embodiments of the present disclosure;

FIGS. 7A and 7B illustrate a graphical user interface (GUI) during some embodiments of the method of FIG. 6, in accordance with some embodiments of the present disclosure;

FIGS. 8A-1 and 8A-2 (commonly referred to herein as 8A) and FIGS. 8B-1 and 8B-2 (commonly referred to herein as 8B) illustrate a GUI during some embodiments of the method of FIG. 6, in accordance with some embodiments of the present disclosure;

FIGS. 9A-9E illustrate screenshots of a media choreography assets creation and publishing application during some embodiments of the method of FIG. 6 in accordance with some embodiments of the present disclosure;

FIG. 10 is a flow diagram illustrating an example of a method the media choreography asset distribution, in accordance with some embodiments of the present disclosure; and

FIG. 11 is a block diagram of an example of a computing system with which the present techniques may be implemented, in accordance with some embodiments of the present disclosure.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of digital content-creation tooling, media choreography, data compression, and computer science. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Systems and methods of the present disclosure provide a media choreography system that may include a media choreography asset generation tool and a media choreography publishing tool that allows content creators to make and distributed personalized and interactive experiences that may be specific to locations around the world. These experiences may include audio, video, images, voice interactions, car features or other device feature manipulation such as opening the windows or trunk, wipers and fluid, lighting effects, seat controls or other feature manipulations depending on the device. The media choreography system may include the generation tool, a publishing application programming interface (API), and various data standards.

In some examples, the media choreography system may utilize geolocations such as latitude and longitude or other location information for specific locations or in combination as edge points to describe an area, as well as a radius of relevance or how far away from a particular point an experience is appropriate. The system works via web and mobile app standards agnostically with MapBox, Google Maps, Apple Maps and other applications as an authoring tool and a publishing tool.

Customers of the media choreography system may ingest the output of the publishing tool into Car dashboard apps, CarPlay-compatible iOS apps, custom Android apps for freestanding IoT bathrooms, mobile apps for phones, discovery apps for augmented reality (AR) wearables or other applications that may interface with a publishing API.

In various embodiments of the present disclosure, content creators, also referred to herein as developers, may have the ability to select features of a vehicle or other device system that has independently operable connected devices and trigger those connected devices at specific timecodes in the media content playback for narrative purposes. This connected device control may include vehicle features including heating, ventilation, and air condition (HVAC) system hot/cold intensity, windows open/close to percentage, windshield wipers and fluid, trunk opening and closing, seat massage, seat position adjust, interior lights, horn honking, external speaker, or other connected devices that may depend on the system (e.g., an automatic flush function on a smart toilet). The content creator may have the ability to work with immersive audio support, including Dolby Atmos, and provide location-specific content triggers so that playback of the media choreography asset occurs right as end-users drive, walk, or fly by a specific place. The content creator may have access to tools that allow for graceful degrade to vehicles, which are not compatible with the full experience, such as providing backward compatibility for hardware which does not have the features available or conditional storytelling so that a user's experience is as good as it can be within the limitations of the available connected devices and hardware of the consuming device.

In various embodiments of the present disclosure the media choreography asset system may include exterior environment controls such that a user's arrival at a destination can result in building exterior lights and projectors coming on or other devices and may support “hand off” from a vehicle dashboard app to a mobile app as a user exits a vehicle to continue the experience provided by the media content asset on foot outside of the vehicle. The media choreography asset tool may include back timing controls of media content based on user or vehicle velocity and direction of travel. In an airplane, this feature is used to pick out key stories and details from a route of flight. Other embodiments, include indexing of media choreography assets and their underlying content that are relevant to a location, content unlock for destination arrival, pre-caching of at least a portion of the media choreography asset for offline experience, understanding of category of hardware, or other features described within the present disclosure.

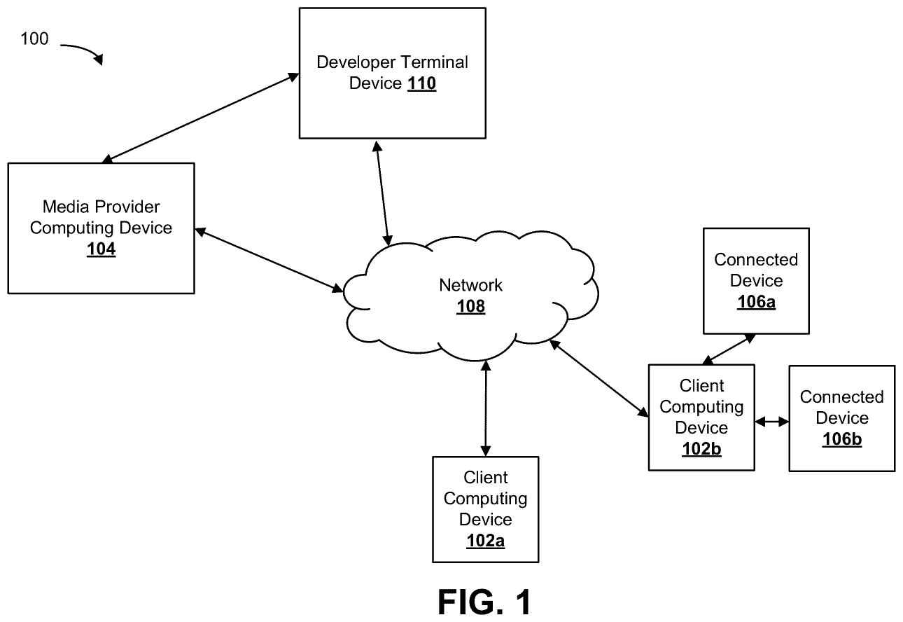

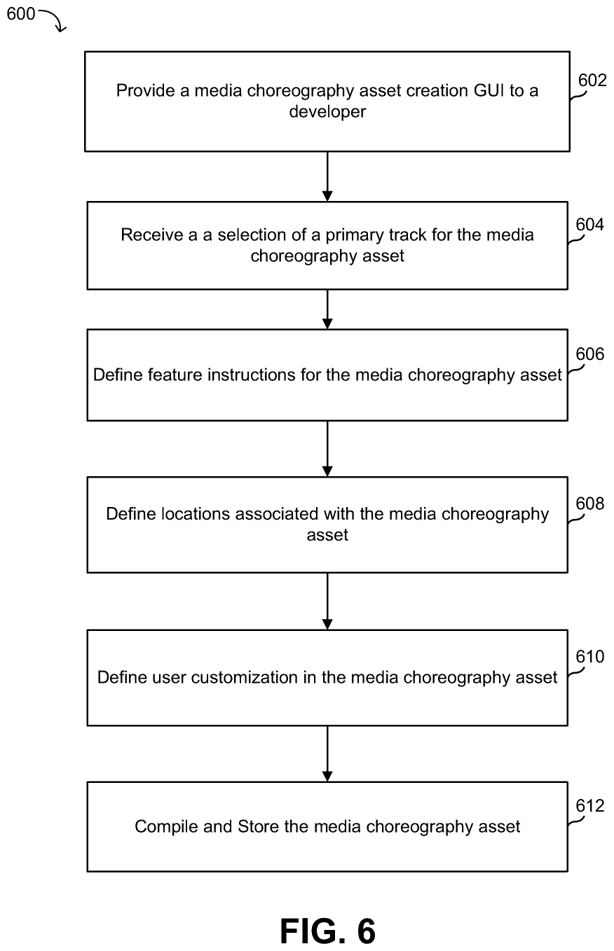

FIG. 1 depicts a block diagram of an example of a media choreography system 100, consistent with some embodiments. In some embodiments, the media choreography system 100 may include one or more client computing devices (e.g., a client computing device 102a and a client computing device 102b), a media provider computing device 104, one or more connected devices (e.g., a connected device 106a and a connected device 106b), and a developer terminal device 110. The client computing devices 102a and 102b and the media provider computing device 104 may be in communication with each other over a network 108. In various embodiments, the client computing device 102a may be associated with a first user and the client computing device 102b may be associated with a second user (e.g., in memory of the media choreography system 100 in virtue of user profiles). These various components may be implemented with computing devices like that shown in FIG. 6.

In some embodiments, the client computing devices 102a and 102b may be implemented using various combinations of hardware or software configured for wired or wireless communication over the network 108. For example, the client computing devices 102a and 102b may be implemented as a wireless telephone (e.g., smart phone), a tablet, a personal digital assistant (PDA), a notebook computer, a personal computer, a connected set-top box (STB) such as provided by cable or satellite media providers, a personal assistant/home automation device, or a video game system console, a head-mounted display (HMD), a watch, an eyeglass projection screen, an autonomous/semi-autonomous device, a vehicle (e.g., a truck, a car, a bus, an airplane, a boat, or other vehicle), a user badge, a computing device incorporated into a product, or other client computing devices. In some embodiments, the client computing devices 102a and 102b may include various combinations of hardware or software having one or more processors and capable of reading instructions stored on a tangible non-transitory machine-readable medium for execution by the one or more processors. Consistent with some embodiments, the client computing devices 102a and 102b include a machine-readable medium, such as a memory that includes instructions for execution by one or more processors for causing the client computing devices 102a and 102b to perform specific tasks. In some embodiments, the instructions may be executed by the one or more processors in response to interaction by the user. Two client computing devices are shown, but commercial implementations are expected to include more than one million, e.g., more than 10 million, geographically distributed over North America or the world.

The client computing devices 102a and 102b may include a communication system having one or more transceivers to communicate with other client computing devices or the media provider computing device 104. Accordingly, and as disclosed in further detail below, the client computing devices 102a and 102b may be in communication with systems directly or indirectly. As used herein, the phrase “in communication,” and variants thereof, is not limited to direct communication or continuous communication and can include indirect communication through one or more intermediary components or selective communication at periodic or aperiodic intervals, as well as one-time events.

For example, the client computing devices 102a and 102b in the media choreography system 100 of FIG. 1 may include first (e.g., relatively long-range) transceiver to permit the client computing devices 102a and 102b to communicate with the network 108 via a communication channel. In various embodiments, the network 108 may be implemented as a single network or a combination of multiple networks. For example, in various embodiments, the network 108 may include the Internet or one or more intranets, landline networks, wireless networks, or other appropriate types of communication networks. In another example, the network 108 may comprise a wireless telecommunications network adapted to communicate with other communication networks, such as the Internet. The wireless telecommunications network may be implemented by an example mobile cellular network, such as a long-term evolution (LTE) network or other third generation (3G), fourth generation (4G) wireless network, fifth generation (5G) wireless network or any subsequent generations. In some examples, the network 108 may be additionally or alternatively be implemented by a variety of communication networks, such as, but not limited to (which is not to suggest that other lists are limiting), a satellite communication network, a microwave radio network, or other communication networks.

The client computing devices 102a and 102b additionally may include second (e.g., short-range relative to the range of the first transceiver) transceiver to permit the client computing device 102a and 102b to communicate with each other or other client computing devices via a direct communication channel or to communicate with connected devices 106a or 106b, described in further detail below. Such second transceivers may be implemented by a type of transceiver supporting short-range (i.e., operate at distances that are shorter than the long-range transceivers) wireless networking. For example, such second transceivers may be implemented by Wi-Fi transceivers (e.g., via a Wi-Fi Direct protocol), Bluetooth® transceivers, infrared (IR) transceivers, and other transceivers that are configured to allow the client computing devices 102a and 102b to communicate with each other or other client computing devices via an ad-hoc or other wireless network.

The media choreography system 100 may also include or may be in connection with the media provider computing device 104. For example, the media provider computing device 104 may include one or more server devices, storage systems, cloud computing systems, or other computing devices (e.g., desktop computing device, laptop/notebook computing device, tablet computing device, mobile phone, etc.). In various embodiments, media provider computing device 104 may also include various combinations of hardware or software having one or more processors and capable of reading instructions stored on a tangible non-transitory machine-readable medium for execution by the one or more processors. Consistent with some embodiments, the media provider computing device 104 includes a machine-readable medium, such as a memory (not shown) that includes instructions for execution by one or more processors (not shown) for causing the media provider computing device 104 to perform specific tasks. In some embodiments, the instructions may be executed by the one or more processors in response to interaction by the user. The media provider computing device 104 may also be maintained by an entity with which sensitive credentials and information may be exchanged with the client computing devices 102a and 102b. The media provider computing device 104 may further be one or more servers that hosts applications for the client computing devices 102a and 102b. The media provider computing device 104 may be more generally a web site, an online content manager, a service provider, or other entity who provides media content (e.g., video content, audio content, visual content, text content, audiovisual content, haptic content, media choreograph assets, or any other media content that would be apparent to one of skill in the art in possession of the present disclosure) or services to the user. The media provider computing device 104 may include various applications and may also be in communication with one or more external databases, that may provide additional information that may be used by the media provider computing device 104.

The media choreography system 100 may also include a plurality of connected devices (e.g., a connected device 106a or a connected device 106b). The connected devices 106a and 106b may include any Internet of Things (IoT) devices such as, but not limited to, a refrigerator, a lighting controller, a door, a robot, a heating and cooling system, or other smart device that can be controlled by a central client computing device 102b. In other examples, the connected devices 106a and 106b may be any electro-mechanical devices that are connected and controlled by the client computing device 102a or 102b. As discussed below, the client computing device 102a or 102b may be incorporated into a system such as a vehicle. As such, the connected device 106a or 106b may include door systems, window systems, lighting systems, windshield wiper system, windshield fluid systems, a seat adjustment system, a seat messaging system, a seat heating and cooling system, a heating and cooling system, or any other electro-mechanical devices of a vehicle or other system that would be apparent to one of skill in the art in possession of the present disclosure.

The media choreography system 100 may also include a developer terminal device 110. The developer terminal device 110 may be provided by any client computing device (e.g., client computing device 102a and 102b) and thus include the features and components discussed above. The developer terminal device 110 may be used by a media developer to compile content into a media choreography asset. As discussed herein, the media choreography asset may include a primary media track of audio content or video content and associate a set of geolocations, a set of instructions, a set of triggers, or any other information, controls or instructions that will provide a media experience. While a specific media choreography system 100 is described, one skill in the art in possession of the present disclosure will recognize that other media choreography systems may be contemplated including various components and configurations without departing from the scope of the present disclosure.

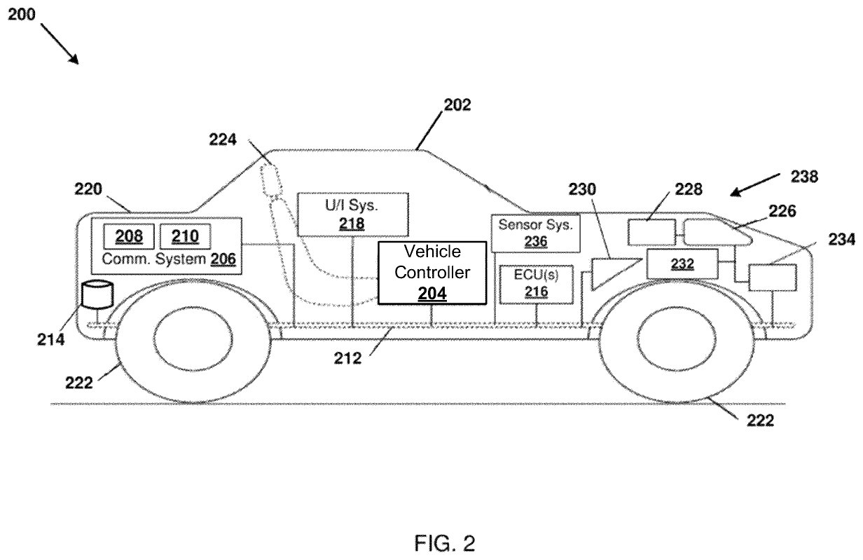

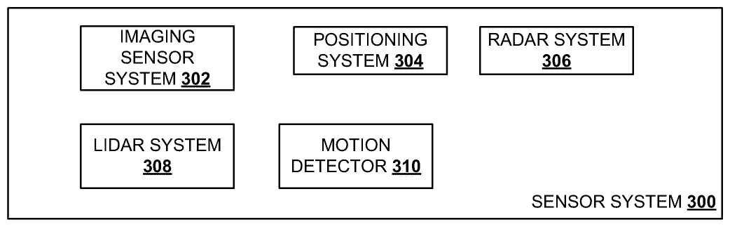

Referring now to FIG. 2, an embodiment of a vehicle 200 is illustrated that may be the vehicles or client computing devices 102a or 102b discussed above with reference to FIG. 1. While the vehicle 200 is illustrated as an car, one of skill in the art in possession of the present disclosure may recognize that the vehicle 200 may be provided by a UAV, a robot, an unmanned vehicular device (e.g., land or water), a boat, a plane, or other vehicular device described above or that would be apparent to one of skill in the art in possession of the present disclosure. In the illustrated embodiment, the vehicle 200 includes a chassis 202 that houses the components of the vehicle 200. Several of these components are illustrated in FIG. 2. For example, the chassis 202 may house a processing system (not illustrated) and a non-transitory memory system (not illustrated) that includes instructions that, when executed by the processing system, cause the processing system to provide a vehicle controller 204 that is configured to perform the functions of the vehicle controllers, or the vehicles discussed below.

The chassis 202 may further house a communication system 206 that is coupled to the vehicle controller 204 (e.g., via a coupling (e.g., a bus 212) between the communication system 206 and the processing system). The communication system 206 may include software or instructions that are stored on a computer-readable medium and that allow the vehicle 200 to send and receive information through the communication networks discussed above. For example, the communication system 206 may include a communication interface 208 to provide for communications through the communication network 112 as detailed above (e.g., a long-range transceiver(s)). In an embodiment, the communication interface 208 may be a wireless antenna that is configured to provide communications with IEEE 802.11 protocols (Wi-Fi), cellular communications, satellite communications, other microwave radio communications or communications. The communication system 206 may also include a communication interface 210 that is configured to provide direct communication with other vehicles or client computing devices, or other devices within a physical environment discussed above with respect to FIG. 1 ((e.g., short-range) transceiver(s)). For example, the communication interface 210 may be configured to operate according to wireless protocols such as Bluetooth®, Bluetooth® Low Energy (BLE), near field communication (NFC), infrared data association (IrDA), ANT®, Zigbee®, Z-Wave® IEEE 802.11 protocols (Wi-Fi), and other wireless communication protocols that allow for direct communication between devices.

The communication system 206 of the illustrated example manages communications between the vehicle 200 and network entities (e.g., a car manufacturer, a telecommunication service provider, an internet service provider, a media provider, a certificate authority, etc.) via a wired or wireless connection (e.g., an IEEE 802.11 wireless connection, a Bluetooth connection, a cable/DSL/satellite modem, a cell tower, etc.). The communication system 206 of the illustrated example maintains network information (e.g., a network address, network settings, etc.) required to send or receive data over the various communication platforms. The communication system 206 manages the connections between the vehicle and outside entities (e.g., a Bluetooth connection between a mobile device and the example vehicle controller 204). In some examples, the communication system 206 may establish communicative connections with service providers that may provide the media provider computing device or different network entities (e.g., a car manufacturer, a telecommunication service provider, an internet service provider, a media provider, a certificate authority, etc.) to send data from the vehicle 200 to the network entities or receive data from the network entities for delivery to the vehicle. In addition, the communication system 206 may communicate with other client computing devices, such as a personal electronic device (e.g., a smartphone, a tablet, a smart watch, etc.), a personal computer (e.g., a desktop, a laptop, etc.), a diagnostic computer (e.g., at a dealership, etc.), or the like. In some examples, one or more computing devices connected to the vehicle 200 via the communication system 206 may transmit and receive information, such as vehicle diagnostic data, media files (e.g., movies, music, television programs, a media choreography asset, or the like.) uploaded to a memory of the vehicle 200, firmware or software updates, driving profiles, environmental information about the physical environment, authentication identifiers (e.g., cryptographic keys), or other vehicle information that would be apparent to one of skill in the art in possession of the present disclosure.

The chassis 202 may also house a vehicle storage system 214 that is coupled to the vehicle controller 204 through the processing system (e.g., via the bus 212). The vehicle storage system 214 may store sensor data, vehicle instructions and rules, security files (e.g., map instances), media choreography assets, or any other information or instructions that would be apparent to one of skill in the art in possession of the present disclosure.

The chassis 202 may also house a plurality of ECUs 216 that are coupled (e.g., via the bus 212) to the vehicle controller 204 through the processing system. The example ECUs 216 of FIG. 2 may be discrete computing devices. The example ECUs 216 may include a processor (e.g., a microcontroller) to process data and execute programmable instructions (e.g., assembly level instructions, functional sequential instructions, or object-oriented instructions). The example ECUs 216 also are provided with on-board memory (e.g., static random access memory (SRAM), electrically erasable programmable read only memory (EEPROM), or Flash memory) to store data received or generated by the ECU 216. The example ECUs 216 are further provided with input or output (I/O) ports such as supply voltage inputs, digital or analog inputs, relay drivers, H-bridge drivers, injector drivers, or logic outputs. These I/O ports are used by the ECU 216 to receive data from sensors and transmit signals to connected devices such as, for example, mechanical components (e.g., actuators) to affect the mechanical components operations based on the operating parameters of the vehicle 200. The received data or the transmitted signals are communicated from the ECU 216 via the data bus 212 or through a directly wired connection between the ECU 216 and the mechanical component.

The example ECUs 216 of FIG. 2 control low level systems (e.g., door controls, headlight controls, engine controls, transmission controls, climate controls, seat controls, mirror controls, trunk controls, or the like.) or high-level systems (e.g., radio systems, voice controls, entertainment systems, a telematic control unit managing a GPS/Navigation system, or the like) connected to the data bus 212. Each ECU 216 monitors its corresponding system by reading sensor signals. These sensors are placed on the mechanical components of the system and report factors such as position, temperature, speed, etc. These factors contribute to if, when, or how the ECU 216 generates output signals to execute control over the corresponding system.

For example, the ECU 216 responsible for door control has sensors monitoring door lock buttons, position of doors (e.g., open or closed), door locks (e.g., engaged or disengaged), or child lock switches (e.g., engaged or disengaged). Based on the readings of these sensors, the door control ECU 216 may, for example, decide on whether to generate a lock engaging signal to the doors of the vehicle 200. In other examples, the vehicle controller 204 may provide instructions to the ECU 216 responsible for door control.

Each of the ECUs 216 may be of different size or complexity according to the system the individual ECU 216 is controlling. In the illustrated example, the ECUs 216 are in communication with other units of the vehicle via the data bus 212. In some examples, the ECUs 216 may send or receive information or driving profiles (e.g., the status of the systems or components of the vehicle, diagnostic information, telemetry data, environmental information, etc.) to a remote device (e.g., a mobile device such as a smartphone, tablet, smartwatch, etc.) via the communication system 206 or may receive information (e.g., commands, driving profiles, operating parameters, firmware/software updates, media files, environmental information, etc.) from the remote device via the communication system 206. For example, such information may be communicated between the ECUs 216 and the remote device using a Bluetooth, Wi-Fi, or near field communication (NFC) connection generated or managed by the communication system 206.

Typically, the ECUs 216 are deployed in a one-to-one fashion. That is, each ECU 216 is provided with processing power and system memory ample enough to control a corresponding single system of the vehicle. Each ECU 216 will vary in size according to the complexity of the corresponding system. In some examples, however, the ECUs 216 in the example vehicle 200 may be more robust than a typical ECU and capable of controlling multiple systems (e.g., an ECM of the ECMs 216 may control the engine and the transmission system). For example, a robust ECU may be provided with amounts of processing power greater than a typical ECU processor (e.g., more cores, faster clocking speeds, larger processing cache, etc.) and higher amounts of random access memory (RAM) may control more than one system as is typical of the average ECU.

The chassis 202 of the vehicle 200 may also house a user interface system 218 coupled to the vehicle controller 204 through the processing system. The user interface system 218 may include components such as a dashboard display system, an audio system (e.g., one or more speakers, a surround sound system (e.g., Dolby Atmos)), a media center, a center console display, user accessible buttons (e.g., climate controls, door lock controls), etc. The user interface system 218 may also include a data store to store media (e.g., movies, music, television programs, podcasts, media choreograph assets, or the like), system firmware, navigation data, diagnostic information, data collected by data collection systems (e.g., cameras mounted externally on the vehicle, weather data collection, or other data collection systems.), driving profiles, or other data, content, or instructions. The example user interface system 218 also functions as a human machine interface that provides options to the user of the vehicle 200 and communicates the user's selected options to the corresponding ECU 216 or the vehicle controller 204.

In the illustrated example of FIG. 2, the chassis 202 of the vehicle 200 may include a body 220, at least two wheels 222, a seat 224, a motor 226, a cooling system 228, a transmission 230, a braking system 232, or battery 234 (e.g., an electrical system). In the illustrated example, the body 220 covers the exterior of the vehicle 200 to protect or contain the other parts of the vehicle 200. In various embodiments of the vehicle of FIG. 2, the ECUs 216, via commands from the vehicle controller 204, may control the braking system 232, the cooling system 228, the transmission 230, the motor 226 or any other vehicle systems that are apparent to one of skill in the art in possession of the present disclosure. In various embodiments, components that enable the vehicle 200 to steer, accelerate, deaccelerate, or perform any other mechanical functions may be referred to a drive system 238. As such, the drive system 238 may include the at least two wheels 222, the motor 226, the cooling system 228, the transmission 230 or any other system used to navigate the vehicle 200 in the physical environment.

In the illustrated example, the motor 226 may be implemented by a combustion engine, a DC electric motor, or an AC electric motor. The motor 226 may be communicatively coupled to the ECUs 216 and the transmission 230. The example ECU 216 may receive operating power from batteries 234 to control components of the motor 226 (e.g., throttle valve, sparkplugs, pistons, fuel injectors, etc.). The ECU 216 for the motor 226 receives signals from a user (e.g., via sensors in a pedal, etc.) or the vehicle controller 204 to determine corresponding control signals to communicate to the example motor 226 (e.g., manipulating throttle valve, firing spark plugs, altering fuel injection quantities, etc.). In the illustrated example, the motor 226 supplies torque to the transmission 230 to drive two or more wheels 222.

In various embodiments, the vehicle 200 may include a sensor system 236 that may be housed in the chassis 202 or provided on the chassis 202. The sensor system 236 may be coupled (e.g., coupled via the bus 212) to the vehicle controller 204 via the processing system. The sensor system 236 may include one or more sensors that gather sensor data about the vehicle 200 or physical environment that may be provided to the vehicle controller 204 via the bus 212. The sensor data (e.g., environmental data) may be used by the vehicle controller 204 to make decisions regarding control signals to provide to ECUs 216 of the vehicle 200 to control the various systems when the vehicle 200 is in use and navigating the physical environment. While a specific vehicle 200 is described, one skill in the art in possession of the present disclosure will recognize that other vehicles or systems that include connected devices may be contemplated without departing from the scope of the present disclosure.

Referring to FIG. 3, the sensor system 300 is illustrated that may be the sensor system 236 of FIG. 2. The sensor system 300 may include an imaging sensor system 302, a positioning system 304, a radar system 306, a lidar system 308, a motion detector 310, a secure sensor 312, or other sensors that would be apparent to one of skill in the art in possession of the present disclosure. In various embodiments, the imaging sensor system 302 may include a plurality of imaging sensors that provide on various locations of the chassis 202. For example, the imaging sensors may include, a two-dimensional image capturing camera, a three-dimensional image capturing camera, an infrared image capturing camera, a depth capturing camera, similar video recorders, and/or a variety of other image capturing devices. The imaging sensor system 302 may be used to gather visual information from the physical environment surrounding the vehicle or within the vehicle, for use in recognizing an object exterior or interior, and other functionality with the vehicle 200. In various examples, the imaging sensor may be mechanically movable, for example, by mounting the camera on a rotating and/or tilting a platform.

The sensor system 300 may also include the positioning system 304 that is coupled to the vehicle controller 204. The positioning system 304 may include sensors for determining the location and position of the vehicle 200 in the physical environment. For example, the positioning system 304 may include a global positioning system (GPS) receiver, a real-time kinematic (RTK) GPS receiver, a differential GPS receiver, a Wi-Fi based positioning system (WPS) receiver, an accelerometer, and/or other positioning systems and components.

The sensor system 300 may include a radar system 306 which may represent a system that utilizes radio signals to sense objects within the physical environment of the vehicle 200. In some embodiments, in addition to sensing objects, the radar system 306 may additionally sense the speed and/or heading of the objects.

The sensor system 300 may include the lidar system 308, the lidar system 308 may include a light generator, for example, a laser device (e.g., a laser used in lidar (e.g., sometimes referred to as an acronym for light detection and ranging (LIDAR)), a laser scanner, a flash device (e.g., a flash LED, an electronic flash, etc.), and/or any other light generator for use in lidar and/or photogrammetry applications that would be apparent to one of skill in the art in possession of the present disclosure. The lidar system 308 may include an imaging sensor or light detector in capturing the light from the light generator that is reflected from objects in the physical environment. For example, the lidar system 308 may utilize any of the imaging sensors in the imaging sensor system 302 or include its own imaging sensor (e.g., camera).

The sensor system 300 may also include a motion detector 310. The motion detector 310 may include an accelerometer, a gyroscope, and/or any other sensor for detecting and/or calculating the orientation and/or movement of the vehicle 200. While some sensors are described, one of skill in the art in possession of the present disclosure will recognize that the sensor system 300 may further include other sensors that may be used in running and updating a media choreography asset.

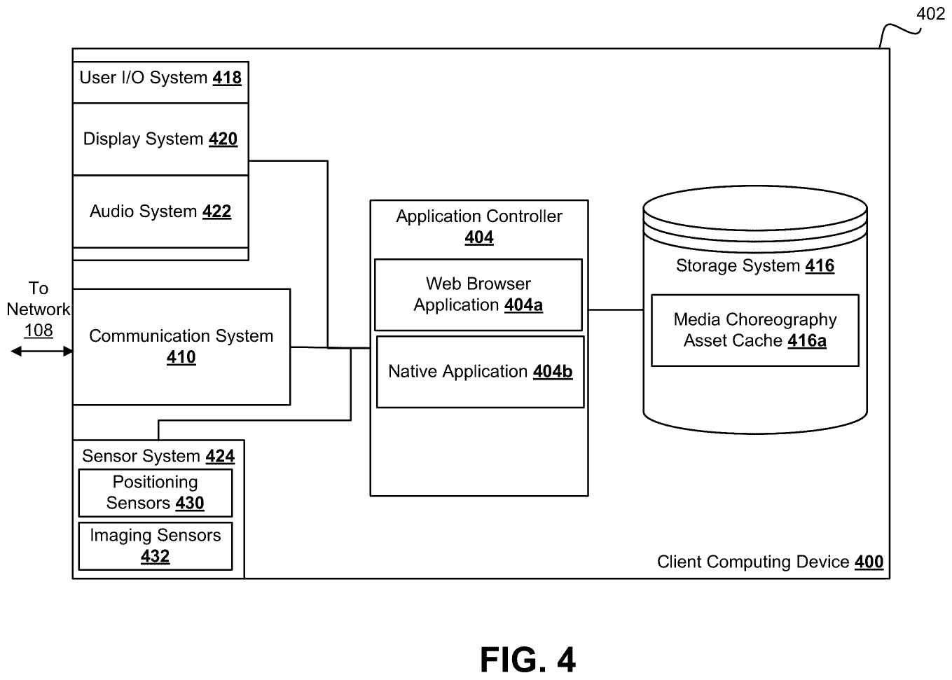

FIG. 4 illustrates a client computing device 400 that may be another embodiment of the client computing device 102a or 102b discussed above with reference to FIG. 1 or the vehicle 200 of FIG. 2. In the illustrated embodiment, the client computing device 400 includes a chassis 402 that houses the components of the client computing device 400. Several of these components are illustrated in FIG. 4. For example, the chassis 402 may house a processing system and a non-transitory memory system that includes instructions that, when executed by the processing system, cause the processing system to provide an application controller 404 that is configured to perform the functions of the application controllers or the client computing devices discussed below. In the specific example illustrated in FIG. 4, the application controller 404 is configured to provide one or more of a web browser application 404a or a native application 404b. The application controller 404 may provide the vehicle controller 204 of FIG. 2 and thus, the vehicle controller 204 may include the web browser application 404a or the native application 404b. As used herein, the application controller 404 and the vehicle controller 204 may refer to the same controller.

The chassis 402 may further house a communication system 410 that is coupled to the application controller 404 (e.g., via a coupling between the communication system 410 and the processing system). The communication system 410 may include software or instructions that are stored on a computer-readable medium and that allow the client computing device 400 to send and receive information through the communication networks discussed above. For example, the communication system 410 may include a communication interface to provide for communications through the network 108 as detailed above (e.g., first (e.g., long-range) transceiver). In an embodiment, the communication interface may include a wireless antenna that is configured to provide communications with IEEE 802.11 protocols (Wi-Fi), cellular communications, satellite communications, other microwave radio communications or communications. The communication system 410 may also include a communication interface (e.g., the second (e.g., short-range) transceiver) that is configured to provide direct communication with other client computing devices 102a or 102b, sensors, storage devices, beacons, the connected devices 106a or 106b, and other devices included in the media choreography system 100 discussed above with respect to FIG. 1. For example, the communication interface may include a wireless antenna that configured to operate according to wireless protocols such as Bluetooth®, Bluetooth® Low Energy (BLE), near field communication (NFC), infrared data association (IrDA), ANT®, Zigbee®, Z-Wave® IEEE 802.11 protocols (Wi-Fi), or other wireless communication protocols that allow for direct communication between devices.

The chassis 402 may house a storage device (not illustrated) that provides a storage system 416 that is coupled to the application controller 404 through the processing system. The storage system 416 may be configured to store data, applications, or instructions described in further detail below and used to perform the functions described herein. The storage system 416 may include a media choreography asset cache 416a for storing media choreography assets or portions thereof when connection via the network 108 to the media provider computing device is unavailable. In various embodiments, the chassis 402 also houses a user input/output (I/O) system 418 that is coupled to the application controller 404 (e.g., via a coupling between the processing system and the user I/O system 418). In an embodiment, the user I/O system 418 may be provided by a keyboard input subsystem, a mouse input subsystem, a track pad input subsystem, a touch input display subsystem, a microphone, an audio system 422 (e.g., one or more speakers, a surround sound system (e.g., Dolby® Atmos) or the like), a haptic feedback system, or any other input/output subsystem that would be apparent to one of skill in the art or discussed herein (e.g., connected devices). The chassis 402 also houses a display system 420 that is coupled to the application controller 404 (e.g., via a coupling between the processing system and the display system 420) and may be included in the user I/O system 418. In some embodiments, the display system 420 may be provided by a display device that is integrated into the client computing device 400 and that includes a display screen (e.g., a display screen on a laptop/notebook computing device, a tablet computing device, a mobile phone, or wearable device), or by a display device that is coupled directly to the client computing device 400 (e.g., a display device coupled to a desktop computing device by a cabled or wireless connection).

The chassis 402 may also house a sensor system 424 that may be housed in the chassis 402 or provided on the chassis 402. The sensor system 424 may be coupled to the application controller 404 via the processing system. The sensor system 424 may include one or more sensors that gather sensor data about the client computing device 400, a user of the client computing device 400, the physical environment around the client computing device 400 or other sensor data that may be apparent to one of skill in the art in possession of the present disclosure. For example, the sensor system 424 may include positioning sensors 430 that may include a geolocation sensor (a global positioning system (GPS) receiver, a real-time kinematic (RTK) GPS receiver, or a differential GPS receiver), a Wi-Fi based positioning system (WPS) receiver, an accelerometer, a gyroscope, a compass, an inertial measurement unit (e.g., a six axis IMU), or any other sensor for detecting or calculating orientation, location, or movement that would be apparent to one of skill in the art in possession of the present disclosure. The sensor system 424 may include an imaging sensor 432 that may include an imaging sensor such as a camera, a depth sensing camera (for example based upon projected structured light, time-of-flight, a lidar sensor, or other approaches), other imaging sensors (e.g., a three-dimensional image capturing camera, an infrared image capturing camera, an ultraviolet image capturing camera, similar video recorders, or a variety of other image or data capturing devices that may be used to gather visual information from the physical environment surrounding the client computing device 400). The sensor system 424 may include other sensors such as, for example, a beacon sensor, ultra-wideband sensors, a barometric pressure sensor, one or more biometric sensor, an actuator, a pressure sensor, a temperature sensor, an RFID reader/writer, an audio sensor, an anemometer, a chemical sensor (e.g., a carbon monoxide sensor), a sensor from the sensor system 300, or any other sensor that would be apparent to one of skill in the art in possession of the present disclosure. While a specific client computing device 400 has been illustrated, one of skill in the art in possession of the present disclosure will recognize that client computing devices (or other devices operating according to the teachings of the present disclosure in a manner similar to that described below for the client computing device 400) may include a variety of components and/or component configurations for providing conventional computing device functionality, as well as the functionality discussed below, while remaining within the scope of the present disclosure as well.

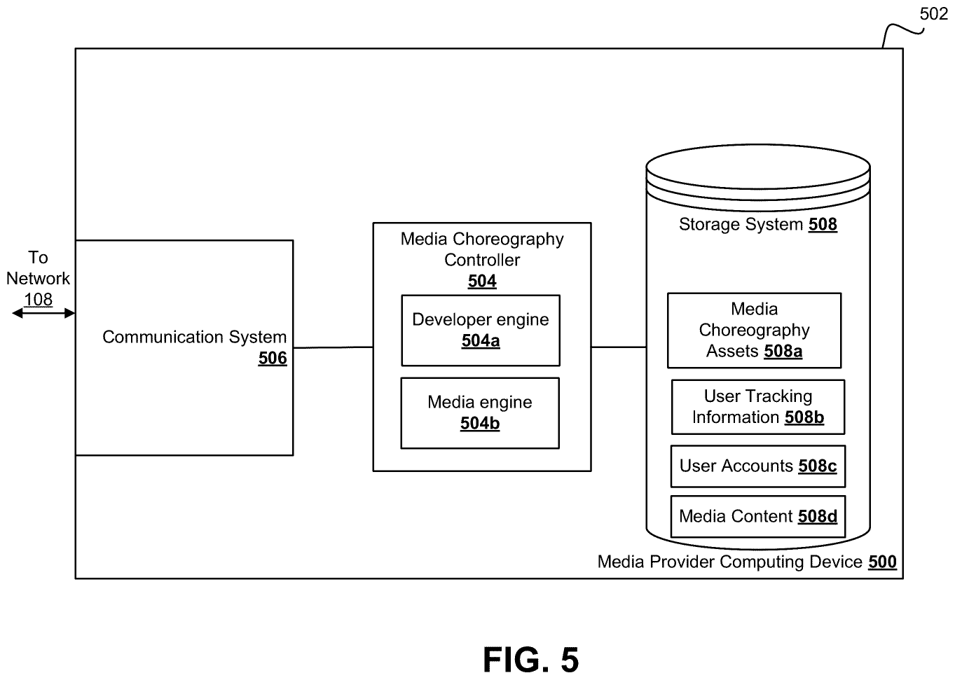

FIG. 5 depicts an embodiment of a media provider computing device 500, which may be the media provider computing device 104 discussed above with reference to FIG. 1. In the illustrated embodiment, the media provider computing device 500 includes a chassis 502 that houses the components of the media provider computing device 500, only some of which are illustrated in FIG. 5. For example, the chassis 502 may house a processing system (not illustrated) and a non-transitory memory system (not illustrated) that includes instructions that, when executed by the processing system, cause the processing system to provide a media choreography controller 504 that is configured to perform the functions of the media choreography controller or media provider server devices discussed below. The media choreography controller 504 may include a developer engine 504a used to create media choreography assets, discussed below. The media choreography controller 504 may include a media engine 504b used to communicate and publish media choreography assets, media content, instructions, and other information with client computing devices.

The chassis 502 may further house a communication system 506 that is coupled to the media choreography controller 504 (e.g., via a coupling between the communication system 506 and the processing system) and that is configured to provide for communication through the network 108 of FIG. 1 as detailed below. The communication system 506 may allow the media provider computing device 500 to send and receive information over the network 108 of FIG. 1. The chassis 502 may also house a storage device (not illustrated) that provides a storage system 508 that is coupled to the content management and versioning controller 504 through the processing system. The storage system 508 may be configured to store media choreography assets 508a, user tracking information 508b, user accounts 508c, media content 508d. or other data or instructions to complete the functionality discussed herein. In various embodiments, the storage system 508 may be provided on the media provider computing device 500 or on a database accessible via the communication system 506. While a specific media provider computing device 500 has been illustrated, one of skill in the art in possession of the present disclosure will recognize that media provider computing devices (or other devices operating according to the teachings of the present disclosure in a manner similar to that described below for the media provider computing device 500) may include a variety of components and/or component configurations for providing conventional computing device functionality, as well as the functionality discussed below, while remaining within the scope of the present disclosure as well.

FIG. 6 depicts an embodiment of a method 600 of media choreography asset creation, which in some embodiments may be implemented with the components of FIGS. 1, 2, 3, 4 and 5 discussed above. As discussed below, some embodiments make technological improvements to Internet-based media content platforms and GUIs used on those platforms. Some embodiments provide for generation of a media choreography asset. One of skill in the art in possession of the present disclosure will recognize that these Internet-centric and digital content-based problems, along with other Internet-centric and digital content-based problems, are solved or mitigated by some of these embodiments. Again, though, embodiments are not limited to approaches that address these problems, as various other problems may be addressed by other aspects of the present disclosure, which is not to suggest that any other description is limiting.

The method 600 is described as being performed by the media choreography controller 504 included on the media provider computing device 104/500. Furthermore, it is contemplated that the client computing device 200 or 400 may include some or all the functionality of the media choreography controller 504. As such, some or all of the steps of the method 600 may be performed by the client computing device 200/400 and still fall under the scope of the present disclosure. As mentioned above, the media provider computing device 104/500 may include one or more processors or one or more servers, and thus the method 600 may be distributed across the those one or more processors or the one or more servers.

The method 600 may begin at block 602 where a media choreography asset creation graphical user interface (GUI) is provided to a developer via a display system of a developer terminal device 110. In an embodiment, at block 602, a developer may access the developer engine 504a via the developer terminal device 110. The developer may login with developer credentials and the developer engine 504a may provide a media choreography asset creation GUI to the developer. The media choreography asset creation GUI may include a plurality of tools for the developer to create and publish the media choreography asset.

The method 600 may proceed to block 604 where a selection of a primary media track for the media choreography asset is received. In an embodiment, at block 604, the media choreography asset creation GUI may present a database of media content tracks (e.g., audio or video tracks) from which the developer may select as a primary media track for the media choreography asset or an option to upload media content tracks to the media provider computing device 500. The developer may select one or more media content tracks to concatenate or media tracks that provide optional branches for the primary media track to branch off from based on a variety of factors such as, for example, graceful degradation when a client computing device that consumes the media choreography asset does not have the full features to operate the media choreography asset, location information associated with the client computing device, a user associated with the client computing device, or other factors discussed herein. The developer engine 504a may receive the selection of the media content for the primary media track. In some embodiments, the developer engine 504a may receive information and a request to create a media choreography asset, the developer engine 504a may select or generate a primary media track based on the information and available media content 508d.

The method 600 may proceed to block 606 where feature instructions for the media choreography asset are defined. In an embodiment, at block 606, the developer, via the media choreography asset creation GUI or the developer engine 504a based on information received, may define feature instructions for the media choreography asset. Each feature instruction may include a timecode and one or more triggers and trigger instructions for that trigger. The timecode may be a time in the primary media track at which to activate the trigger. The trigger may be a feature (e.g., opening or closing of a door, spraying of windshield wiping fluid, or the like) provided by a connected device (e.g., connected device 106a or 106b). As such, a feature instruction may indicate which of one or more connected device to activate, when to activate a feature the connected device, which feature or features the connected device should activate, how the connected device should operate to accomplish the desired feature, where the connected device should be activated, a duration of activation, or other trigger instructions that would be apparent to one of skill in the art in possession of the present disclosure.

The method 600 may proceed to block 608 where locations are defined in the media choreography asset. In an embodiment, at block 608, the locations at which the primary media track should be played are received and incorporated into the media choreography asset. The developer may select geolocations (e.g., latitude and longitude, altitude, or other location information (e.g., indoor positioning coordinates)) and a radius within those geolocations at which the primary media track may be played or features triggered. Furthermore, the locations may include timecodes as to where to start or stop the primary media track when in proximity to the geolocation. As such, a portion of the primary media track may begin at when a proximity condition is satisfied for a first location. The portion of the primary media track may end when the ending timecode is satisfied, and the primary media track may stop until a second proximity condition is satisfied for a second portion of the track. In other embodiments, the media choreography asset may be defined such that the first track stops before it is finished if the proximity condition is no longer satisfied.

In some embodiments, the media choreography asset may be defined such that the order of the proximity conditions for each portion of the primary media track is satisfied before permitting a second portion of the primary media track to begin. However, in other embodiments, the media choreography asset may be defined such that the order of the proximity conditions does not matter. For example, a first portion of the primary media track may be associated with a first location and a first proximity condition and a second portion of the primary media track may be associated with a second location and a second proximity condition. The second portion may also be defined to play only if the first portion has played prior. As such, an end user would be required to satisfy the first proximity condition and the playing of the first portion of the primary media track before that end user can access the second portion of the primary media track even if that end user has satisfied the second proximity condition.

The method 600 may proceed to block 610 where user customizations are defined in the media choreography asset. In some embodiments, at block 610, user customizations may be defined in the media choreography asset. For example, the primary media track include a plurality of content segments that are concatenated together to form the primary media track. In some embodiments, the developer may define track slots that may be filled in with content segments based on user preferences. For example, the primary media track may include a track slot for news, a track slot for sports, a track slot for stock quotes, a track slot for the weather, a track slot for jokes, or the like. These slots may be filled in with content segments when an end user requests the media choreography asset and the selected content segments may be based on past consumption history of the user and user preferences. For example, a user may communicate preferences for weather, news, and jokes but not for stocks or sports. As such, when the media choreography asset is requested, as discussed in more detail below, the media engine 504b will obtain the user preferences. Based on those user preferences, media engine 504b may obtain the media content segments for weather, news and jokes (and any feature instructions or location conditions) and concatenate them into the primary media track before providing the media choreography asset to the user. The selection of the media content segments may be based on information associated with the user such as further user preferences, location information, time of day, media content segment consumption history, or the like. For example, a media content segment for weather may be selected based on the location of the user when making the request. In another example, if the user has already heard a media content segment for a first joke and when the user request the media choreography asset again, a different media content segment with a different joke may be selected and replace the media content segment for the first joke. While discussed as media content segments being incorporated into a primary media track, each primary media track may be concatenated together as well.

The method 600 may proceed to block 612 where the media choreography asset is compiled and stored. In various embodiments, at block 612, the developer engine 504a may compile the information, content and instructions defined by the developer into the media choreography asset. The media choreography asset may be provided as a JavaScript Object Notation (JSON) file, an extensible markup language (XML) file, a comma-separated values (CSV) file, a plain text file or other file type having addresses to the various primary media tracks and as well as defining the feature instructions, user preferences, locations or other instructions that are discussed above or that may be contemplated without departing from the scope of the present disclosure.

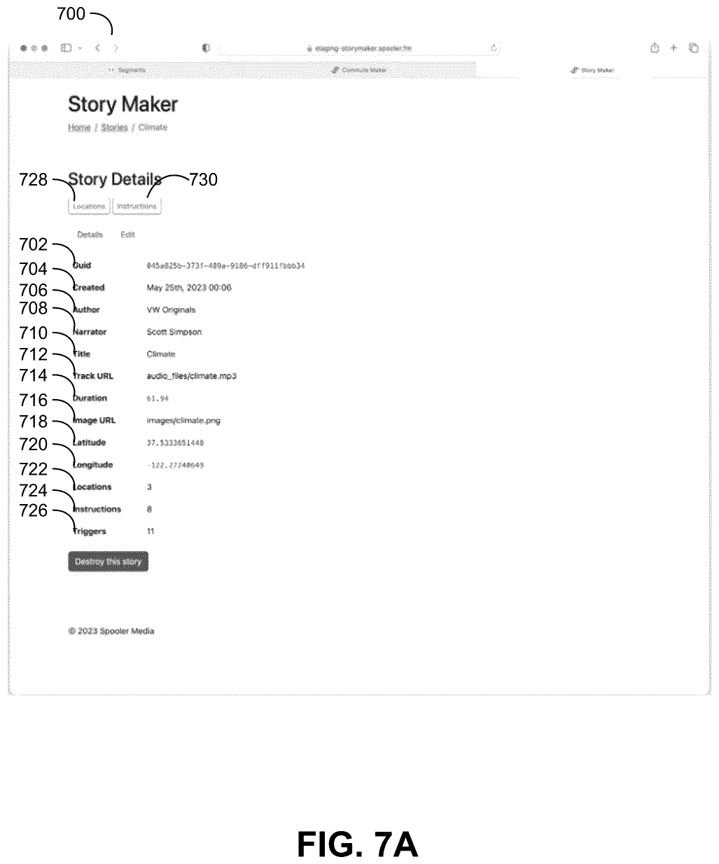

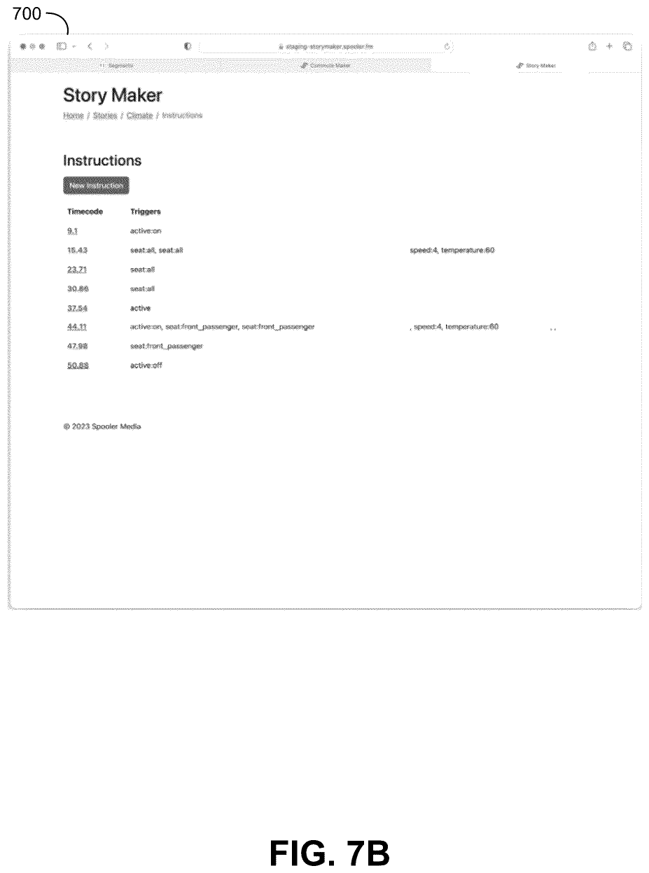

FIGS. 7A and 7B illustrate a media choreography asset creation GUI 700 such as the media choreography asset creation GUI discussed above. As can be seen from FIG. 7A, the media choreography asset creation GUI 700 may include a media choreography asset identifier 702, a creation date 704, an author 706, a narrator 708, a title 710, or any other information that may be displayed when the media choreography asset is presented or associated with the media choreography asset. The media choreography asset creation GUI 700 may also include a primary media track location 712 (e.g., a URL address for the primary media track), a duration of the primary media track, an image identifier 716 (e.g., an image to be displayed while an audio track is being played), a location associated with the primary media track (e.g., a latitude 718 and a longitude 720), a number of locations 722, a number of feature instructions 724 defined, a number of triggers 726 defined, or any other information or instructions that would be apparent to one of skill in the art in possession of the present disclosure. The media choreography asset creation GUI 700 may also include a locations tab 728 to define locations and proximity conditions for those locations. As discussed above, the locations defined in the location tab 728 and counted at locations 722 may define where the primary media track at the primary media track location 712 may be played. The media choreography asset creation GUI 700 may also include a feature instruction tab 730 to define triggers for the connected devices 106a or 106b, the trigger instructions, and timecodes as to when in the primary media track that the triggers are activated. As discussed above, the features defined in the feature instruction tab 730 and counted at instructions 724 and triggers counted at 726 may define when and what triggers the primary media track at the primary media track location 712.

FIG. 7B illustrates the media choreography asset creation GUI 700 when the feature instructions tab 728 is selected. As illustrated in FIG. 7B, a plurality of feature instructions 732-746 may be defined. The feature instructions 732-746 may include a timecode 748 which indicates at which time in the primary media track to activate the feature instructions. The feature instructions 732-746 may include one or more triggers 750, which denote which connected device is performing the feature and which feature that connected device is performing. The feature instructions 732-746 may also include trigger instructions 752, which may provide instructions as to how that connected device should operate its feature. For example, feature instruction 734 may include a timecode of “15.43” such that the trigger of the feature occurs at that time. The trigger 750 for feature instruction 734 may include two seat triggers for a seat control system in a vehicle such as the vehicle 200 of FIG. 2. The seat triggers are for all the seats controlled in the vehicle. The trigger instructions include a speed of the seat movement at “4” and adjusting a climate control feature of the seat to “60” degrees Fahrenheit.

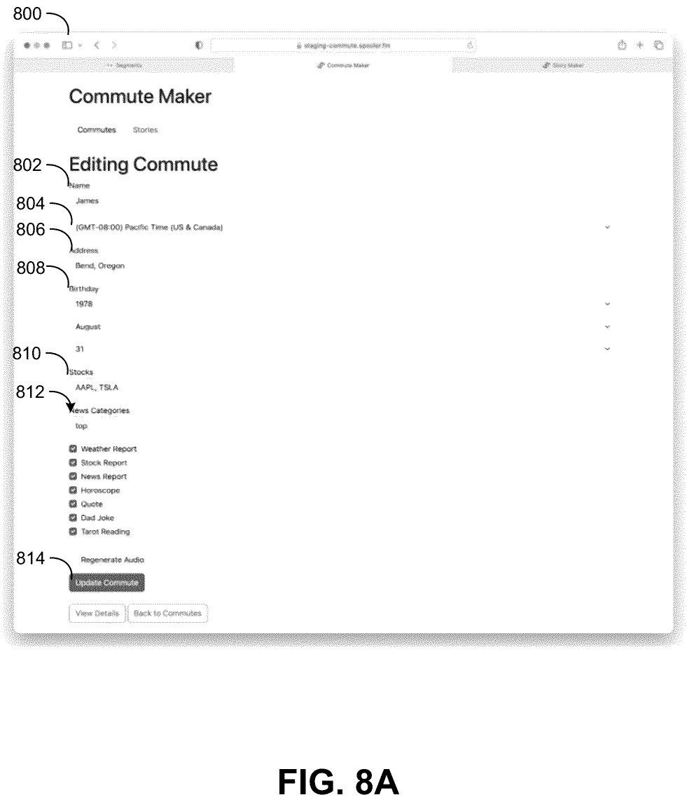

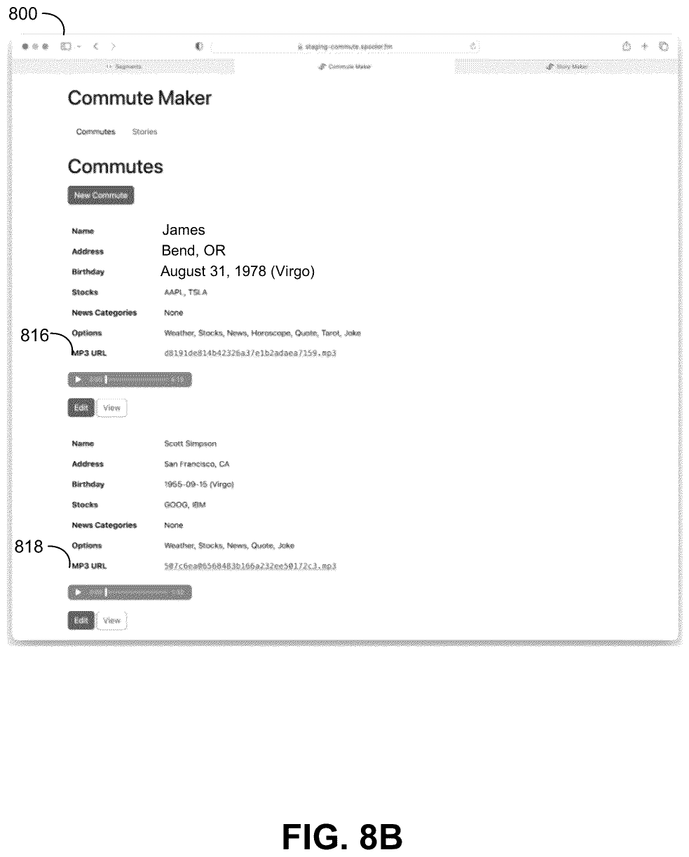

FIGS. 8A-8B illustrate the media choreography asset creation GUI 800 where an end user provides inputs in or preferences in creating the media choreography asset. For example, the media choreography asset creation GUI 800 of FIG. 8A may provide for the user identifier field 802 “James” a time field 804, a location field 806, a birthday field 808, a stock field 810, and a content preference field 812 where various content preferences are selectable to be included in the media choreography asset. When the user selects the update commute button 814, the developer engine 504a may select media content segments to be included in the primary media track of the media choreography asset based on the information in the fields of the media choreography asset creation GUI 800. As illustrated in FIG. 8B, the primary media track 816 for “James” may be different than a primary media track 818 created for “Scott” based on the different information (e.g., location, preferences, birthday, and the like) associated with each user. For example, the primary media track 816 may be four minutes and fifteen seconds while the primary media track 818 may be one minute and thirty-two seconds.

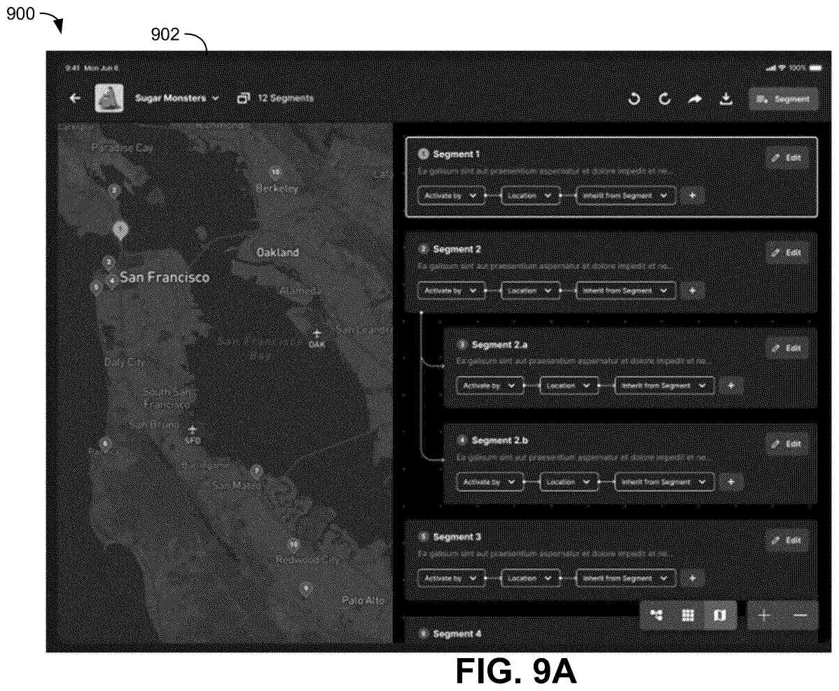

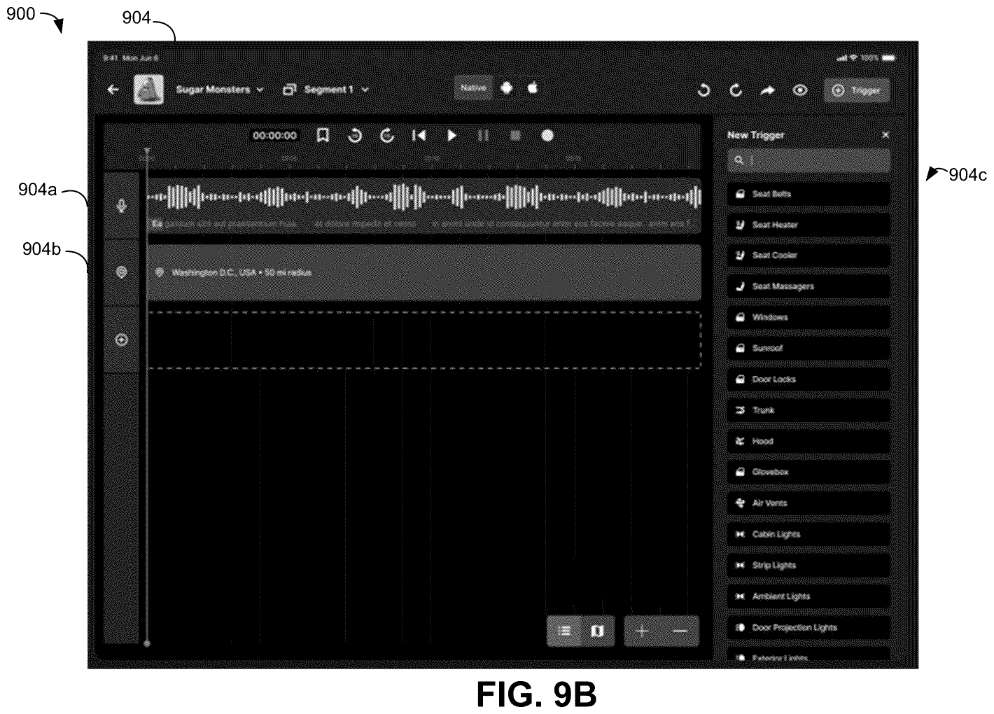

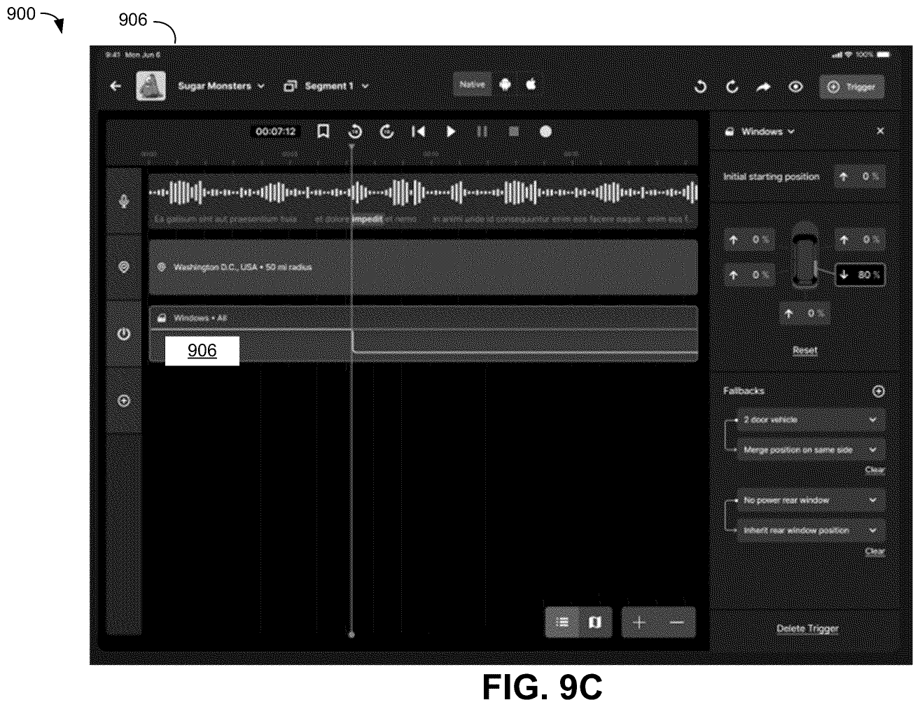

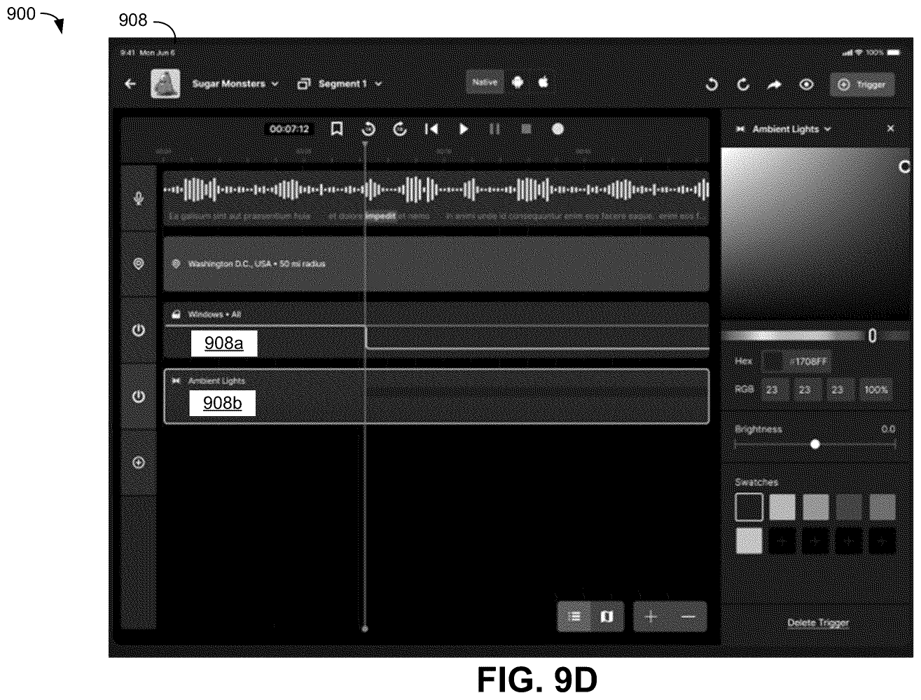

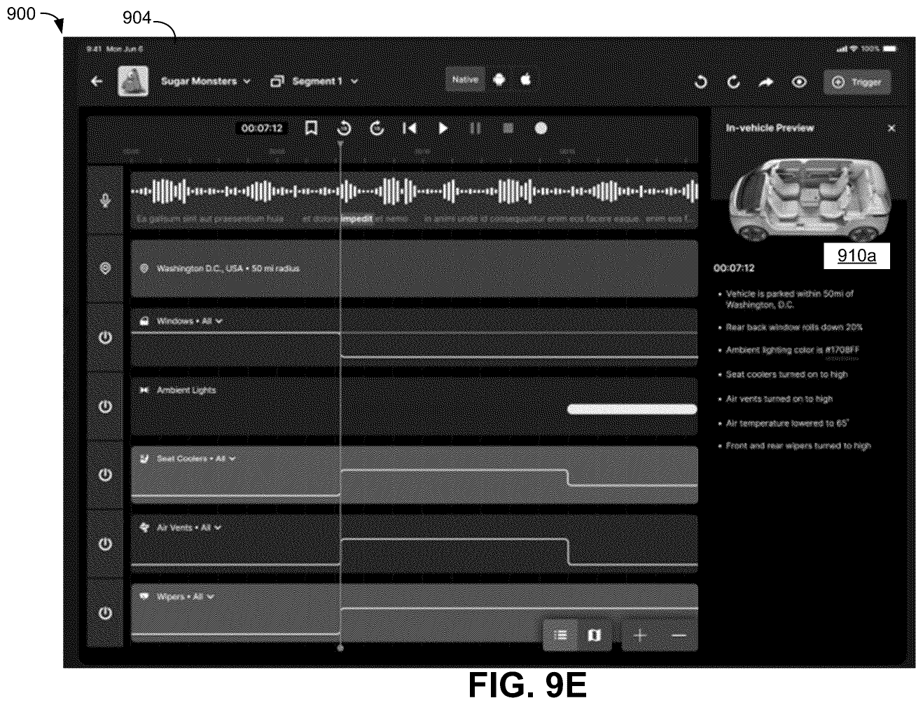

FIGS. 9A-9E illustrate another media choreography asset creation application 900 that provides a media choreography asset creation GUI as discussed above. Specifically, FIGS. 9A-9E illustrate a developer application that may be used to create a media choreography asset. For example, FIG. 9A illustrates a media choreography asset creation GUI 902 where a developer or an end user may generate a media choreography asset by combining individual sub-media choreography assets or segments. These segments may be associated with a geolocation. As such, a developer or end user can create a “choose your own adventure” media experience where the segments play when a user reaches a geolocation.

FIG. 9B illustrates a media choreography asset creation GUI 904 where a developer may add a primary track 904a and a location 904b. The developer has the option to add any number of triggers 904c to provide dynamic spatial experience in a vehicle. FIG. 9C illustrates a media choreography asset creation GUI 906 where a window trigger 906a is selected and provides a developer with tools to provide the media choreography asset with options if the vehicle does not include powered windows (e.g., graceful degradation). It also provides tools to allow the developer to define the window triggers (e.g., lower the rear passenger side window 20% at time 7:12 in the primary audio track. FIG. 9D illustrates a media choreography asset creation GUI 908 where multiple triggers 908a (e.g., windows) and 908b (e.g., lighting) operate together. FIG. 9E illustrates a media choreography asset creation GUI 910 where the developer may preview the effects in a dynamic vehicle rendering. As illustrated, at track time 7:12 in the audio track, the vehicle is parked within 50 mi of Washington, D.C., the rear passenger window rolls down 20%, ambient lighting color is #170BFF, seat coolers are turned to high, air vents turned on to high, air temperature is lowered to 65 degrees, and the front and rear wipers are turned to high. A vehicle graphic 910a may illustrate the triggers that are occurring in the preview.

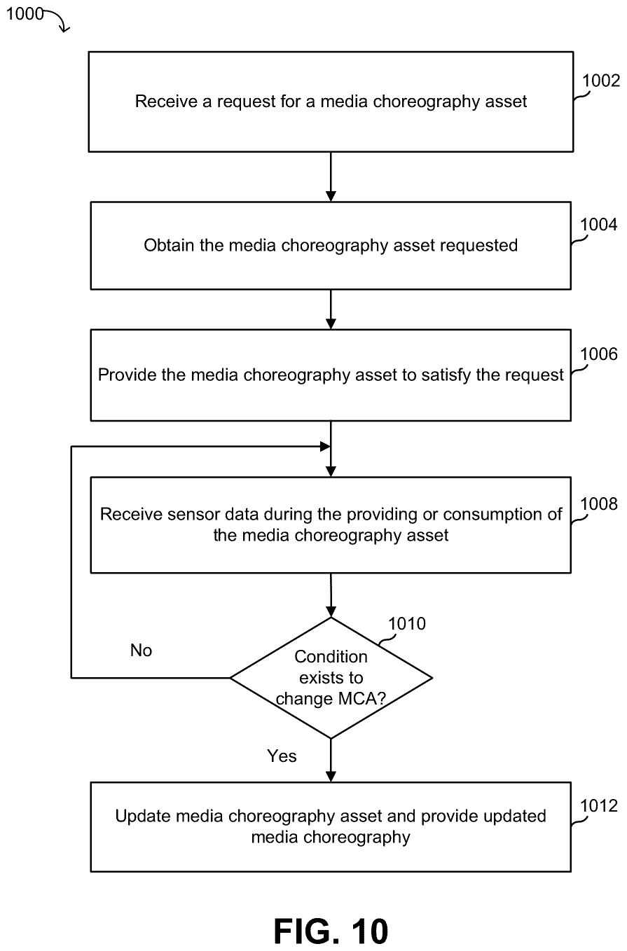

FIG. 10 depicts an embodiment of a method 1000 of media choreography, which in some embodiments may be implemented with the components of FIGS. 1, 2, 3, 4 and 5 discussed above. As discussed below, some embodiments make technological improvements to Internet-based media content platforms and GUIs used on those platforms. Some embodiments provide for media choreography asset consumption and real-time updates. One of skill in the art in possession of the present disclosure will recognize that these Internet-centric and digital content-based problems, along with other Internet-centric and digital content-based problems, are solved or mitigated by some of these embodiments. Again, though, embodiments are not limited to approaches that address these problems, as various other problems may be addressed by other aspects of the present disclosure, which is not to suggest that any other description is limiting.

The method 1000 is described as being performed by the media choreography controller 504 included on the media provider computing device 104/500. Furthermore, it is contemplated that the client computing device 200 or 400 may include some or all the functionality of the media choreography controller 504. As such, some or all of the steps of the method 1000 may be performed by the client computing device 200/400 and still fall under the scope of the present disclosure. As mentioned above, the media provider computing device 104/500 may include one or more processors or one or more servers, and thus the method 1000 may be distributed across those one or more processors or the one or more servers.

The method 1000 may begin at block 1002 where a request is received for a media choreography asset to play on a client computing device. In an embodiment, at block 1002, the media engine 504b may receive a request for a media choreography asset to play on the client computing device 102b that includes at least one of the audio system 422 or the display system 420 configured to output at least one of audio content or video content, respectively. The client computing device 102b may have control over at least one connected device 106a or 106b that has the ability provide a sensory output to a user. As discussed above, the sensory output may include one or more features that the connected device provides other than an audio content via an audio system or a video content via a display system. As such, the connected device may include no audio system or display system. For example, the sensory output for the vehicle 200 example may include a seat movement, a window movement, washer fluid spray, door or trunk opening, lighting activation or deactivation, a tactile activation, or other features that would be apparent to one of skill in the art in possession of the present disclosure. The request may be received by the media provider computing device 104 via the network 108 from the client computing device 102b. The user of the web browser application 404a or the native application 404b may provide the request via the communication system 410 of the client computing device 102b.

In various embodiments, the request may provide an indication of a media device configuration that includes at least one of a type of the audio system 422, a type of the display system 420, or a type of the at least one connected device 106a or 106b. For example, the indication may include at least one of a client computing device identifier that indicates the media device configuration of the client computing device 102b, or the indication may include the media device configuration identified by the client computing device 102b. In other words, the client computing device identifier may be used by the media engine 504b to look up the client computing device to determine what features and connected devices it may have. For example, the client computing device identifier may include a VIN number of the vehicle 200 from which the media engine 504b may determine a make and model of the vehicle 200 and, which package of components are included on the vehicle 200. In other embodiments, the client computing device 102b may report the media device configuration identified by that client computing device 102b. For example, the client computing device 102b may determine it is connected to various connected devices (e.g., the client computing device 102b is connected with a light system of a home) and report those connected devices to the media engine 504b.

In various embodiments, sensor data is received from the client computing device 102b with the request. The media engine 504b of the media provider computing device 500 may receive sensor data from the client computing device 102b. For example, the media engine 504b may receive sensor data from the sensor system 300 or 424 as described above such as, for example, a geolocation, an acceleration, a velocity, a temperature, an altitude, user presence detection, imaging data, or other sensor data described herein or that would be apparent to one of skill in the art in possession of the present disclosure. In other embodiments, user information may also be received with the request.

The method 1000 may proceed to block 1004 where the requested media choreography asset is obtained. In an embodiment, at block 1004, the media engine 504b may obtain the media choreography asset from a media choreography asset database 508a that stores a plurality media choreography assets. The media choreography asset requested may include a media choreography asset created according to method 600, discussed above. As such, the media choreography asset may include a primary media track that includes at least one of an audio track to be presented via the audio system 422 or a video track to be presented via the display system 420. The media choreography asset may include a trigger that includes a set of instructions to operate a set of the at least one connected device 106a or 106b at a timecode in the primary media track and for a duration during the playing of the primary media track. In other embodiments, the request of block 1002 may cause the media engine 504b, at block 1004, to create a media choreography asset according to method 600.

In various embodiments, the media choreography asset may be obtained as a direct request or may be obtained based on sensor data or user information received with the request. For example, the sensor data may indicate a geolocation or a navigation path that includes a plurality of geolocations that the client computing device 102b will likely be at in the future. The media choreography asset may be selected from the geolocation data or be created using method 600 based on the locations in the navigation path that are associated with locations defined in the media choreography assets in the media choreography asset database 508a or locations associated with the media content 508d such that the media engine 504b may generate a media choreography asset selected from the media content 508d using the geolocation data. In other examples, the media choreography assets or the media content included in the media choreography asset may be generated or obtained based on the user information or past history of user consumption of the media choreography assets. As such, a media choreography asset that has been consumed by a user may not be selected again if a condition exists to select that previously consumed media choreography asset. Thus, a different media choreography asset may be selected for that satisfied condition. For example, if a user has experienced a first media choreography asset when passing by a landmark in that user's vehicle, the next time that the user passes by that landmark (e.g., satisfies a proximity condition of a location associated with the media choreography asset), the media engine 504b may play another media choreography asset or not obtain a media choreography asset at all. Furthermore, user information may be used to generate the media choreography asset such as in the example described in FIGS. 8A and 8B where a primary media track is generated based on user information and preferences that may be received in the request at block 1002.

In various embodiments, the media engine 504b may modify the media choreography object based on the media device configuration received in the request. For example, the media engine 504b may modify at least one of the primary media track or triggers of the media choreography asset based on the media device configuration. These embodiments may describe a graceful degradation of the media choreography asset based on the media device configuration for the client computing device and its associated connected devices. For example, the media choreography asset may be generated to provide an experience (e.g., primary media track in combination with the triggers) on a specific media configuration (e.g., type of client computing device in combination with connected devices). However, other users may want to consume the media choreography asset that may have a client computing device that does not include all the connected devices, the connected devices included in the client computing device may not include all the features, or the client computing device may include alternative connected devices. As such, the media engine 504b may adjust the media choreography asset to meet the media device configuration of the client computing device requesting the media choreography asset or the media engine 504b may generate a set of instructions as to how the client computing device should consume the media choreography asset based on the media device configuration for that client computing device.

The method 1000 may proceed to block 1006 where the media choreography asset is provided to the client computing device. In an embodiment, at block 1004, the media engine 504b may provide the media choreography asset to the client computing device 102b via the network 108. The providing of the media choreography asset to the client computing device 102b may cause the primary media track to play via at least one the audio system 422 or the display system 420 and causes the client computing device 102b to operate any indicated connected device 106a or 106b according to the set of instructions at the timecode in the primary media track. In various embodiments, the primary media track and the triggers that include the set of instructions for activating features of the one or more connected device 106a or 106b may be streamed to the client computing device 102b. In other embodiments, the entire media choreography asset may be provided to the client computing device 102b. In some embodiments, the providing of the media choreography asset to the client computing device 102b may include providing the set of instructions determined for the specific media device configuration of the client computing devices and its connected devices. Specifically, the data file of the media choreography asset 508a along with the media content 508d (e.g., images, videos, audio) for the media choreography asset 508 are hosted on the media provider computing device 500 and delivered over the internet as requested by the client computing devices 102a or 102b or pushed to the client computing devices 102a or 102b. In other embodiments, the data file of the media choreography asset 508a along with the media content 508d (e.g., images, videos, audio) for the media choreography asset 508 may be delivered on a tangible machine-readable medium to the client computing devices 102a or 102b to be used.

The method 1000 may proceed to block 1008 where sensor data is received from the client computing device during the playing of the media choreography asset. In an embodiment, at block 1008, the media engine 504b of the media provider computing device 500 may receive sensor data from the client computing device 102b. For example, the media engine 504b may receive sensor data from the sensor system 300 or 424 as described above such as, for example, a geolocation, an acceleration, a velocity, a temperature, an altitude, user presence detection, imaging data, or other sensor data described herein or that would be apparent to one of skill in the art in possession of the present disclosure.

The method 1000 may proceed to decision block 1010 where a determination is made, based on the sensor data whether a condition exists, to change the media choreography asset for unconsumed portions of the media choreography asset. For example, the media engine 504b may determine whether to change the playing of at least one of the primary media track or the trigger(s) of the media choreography asset. The media engine 504b may make the change based on sensor data. Using the example of the vehicle 200, if the driver is proceeding through a location faster than expected based on location information and speed information obtained from the vehicle 200, the media engine 504b may cause the vehicle 200 to skip certain portions of the primary media track or triggers or speed up the playback of the primary media track and triggers. In another example, the sensor data (e.g., images obtained from the imaging sensors 432, biometric data obtained from a biometric sensor, pressure sensors in a seat of the vehicle 200 or the like) may indicate presence of one or more users in the vehicle 200 and where in the vehicle 200 those users are located. Specific triggers may be activated or deactivated based on how many occupants or where those occupants are located in the vehicle 200. As a specific example, a seat trigger for a rear passenger-side seat may be activated to begin with, but if the occupant moves from the rear passenger-side seat to the rear driver-side seat, the sensor data may indicate this move and the media engine 504b may adjust the triggers to activate subsequent features in the media choreography asset to the rear driver-side seat where those features were previously deactivated and deactivate features in the rear passenger-side seat. If no condition exists at decision block 1010, the media engine 504b may continue to monitor received sensor data.

If at decision block 1010, the condition exists, the method 1000 may proceed to block 1012 where instructions are provided to the client computing device to change the playback of the media choreography asset that has not been played. In an embodiment, at block 1012, the media engine 504b may provide instructions to change at least a portion of the at least one of the primary media track or a trigger that has not been played. As discussed in decision block 1010, the media engine 504b may generate instructions based on the sensor data and the condition existing and provide those instructions that change the playback to the media choreography asset to the client computing device 102b, which may cause the client computing device 102b to consume the media choreography asset differently than what was originally requested.

In some embodiments of method 1000, the media choreography asset may require that the user move away from the client computing device 102b to another client computing device such as the client computing device 102a or the user may decide to move away from the client computing device 102b while the media choreography asset is still being consumed but the user still desires to experience the media choreography asset. As such, an indication may be received during the playback of the media choreography asset that the playback of the media choreography asset will be transferred to another client computing device. The indication may be determined based on the sensor data that is being provided to the media engine 504b or the indication may be a specific request from the user consuming the media choreography asset's experience. The media engine 504b may stop providing the media choreography asset to the client computing device 102b and start providing the remainder of the media choreography asset to the client computing device 102a. The changing of client computing devices may result in the client computing device 102a not having connected devices or features itself to operate the triggers defined in the media choreography asset. As such, the media engine 504b may gracefully degrade the media choreography asset or portion of that media choreography asset that is being provided to the client computing device 102a as described herein.

In a specific example, the user may be consuming the media choreography asset in the user's vehicle 200 as the user is driving. The user may come to a waypoint such as a landmark. The media choreography asset may instruct the user to stop and leave the vehicle 200 or the user may leave the vehicle 200 to investigate the landmark further. The media engine 504b based on sensor data or specific instructions by the user may determine that the user will no longer be presenting the media choreography asset and that the user is on the move. As such, the media engine 504b may determine that the user's mobile computing device or a client computing device at the landmark should be providing the media choreography asset. The media engine may begin providing the media choreography asset to that different client computing device where the media choreography asset left off at the vehicle 200.

In some embodiments of the present disclosure, the media choreography asset may include a secondary track or secondary triggers that are dedicated to another client computing device. As such, more than one client computing device and respective connected devices may be participating in the experience provided by the media choreography asset. The media engine 504b may provide the media choreography asset to the other client computing device based on predefined conditions being satisfied. For example, the user may be experiencing the media choreography asset in that user's vehicle 200, and as the user approaches the user's house or some other participating location having a client computing device, the media engine 504b may provide the media choreography asset having the secondary track or secondary triggers to that client computing device such that that client computing device and its connected devices participate in the media choreography asset. For example, as the sensor data indicates that the location of the vehicle 200 satisfies a proximity condition to a client computing device at the user's home, that client computing device may received the media choreography asset from the media engine 504b and activate features for connected devices at timecodes defined by the triggers in the media choreography asset. In a specific example, the approach of the vehicle may cause the sprinkler system of the home to activate to emulate a rainstorm, or outdoor landscaping lighting or lights on the home may flicker to emulate a haunted house when the primary media track of the media choreography asset is telling a scary story about a family arriving at haunted cabin. As such, multiple client computing devices may operate in unison based on the timecodes in the media choreography asset for triggers of connected device features and sensor data to provide the desired experience of the media choreography asset.

In some embodiments of the present disclosure, the sensor data received at block 1008 may include location data. The media engine 504b may determine, based on the location data, that the client computing device is approaching an area from which the client computing device cannot make a network connection with the network. As such, the media engine 504b may provide a portion of the media choreography asset to the client computing device 102b prior to the client computing device entering the area to cache a portion of the media choreography asset. The portions of the media choreography asset that are cached is based on an anticipated duration of the client computing device being in the area or portions of the media choreography asset that are to be played at locations in the area. When to cache the portion of the media choreography asset may be based on other sensor data such as speed of the client computing device, network speed, or other sensor data. The caching may allow the stream of media choreography to operate uninterrupted. Streaming the media choreography asset may be important in some situations to allow the media engine 504b to provide real-time updates to the media choreography based on sensor data that is being received. As such, caching only the portions necessary instead of the entire media choreography is beneficial in some situations and saves on network and storage resources as the entire media choreography asset does not have to be resent each time it is updated.

Thus, the systems and methods of the present disclosure provide a media choreography system for generating and presenting media choreography assets that include primary audio or video track and various embedded triggers for devices connected to the client computing device that provide other experiences besides audio and video. The media choreography asset may be updated as it is consumed or may be gracefully degraded based on the client computing device that is requesting the media choreography assets. User information or various sensor data may be used to update or adjust a media choreography asset prior to or during consumption. Various client computing devices may consume the media choreography asset in unison to provide a richer experience to the user consuming the media choreography asset. In some embodiments, a portion of the media choreography asset may be cached with the client computing device based on known lack of network connectivity with a particular geolocation or geo-area as the user approaches the area having insufficient network resources. The caching may allow the updating of the media choreography asset as it is being consumed in a stream but providing uninterrupted consumption of the media choreography asset in areas where streaming over a network is not possible. As such, the media choreography assets of the present disclosure provide a richer media experience to an end user and do so by efficiently communicating the media choreography assets to reduce use of network resources and storage resources of the database and client computing devices.

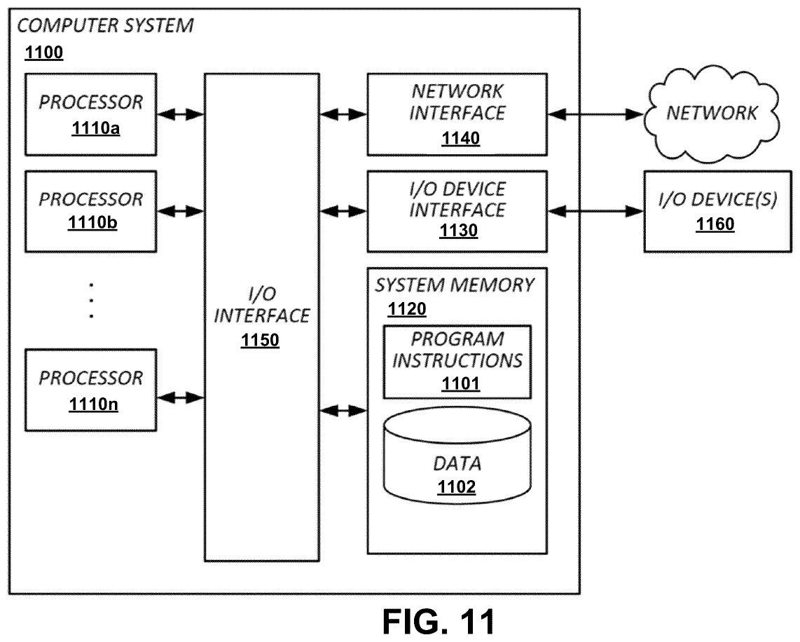

FIG. 11 is a diagram that illustrates an exemplary computing system 1100 in accordance with embodiments of the present technique. The client computing devices 112a, 112b, and 200, the media provider computing devices 114 and 500, the connected devices 116a and 116b, and the developer terminal device 110, discussed above, may be provided by the computing system 1100. Various portions of systems and methods described herein, may include or be executed on one or more computing systems similar to computing system 1100. Further, processes and modules described herein may be executed by one or more processing systems similar to that of computing system 1100.

Computing system 1100 may include one or more processors (e.g., processors 1110a-1110n) coupled to system memory 1120, an input/output I/O device interface 1130, and a network interface 1140 via an input/output (I/O) interface 1150. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1100. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1120). Computing system 1100 may be a uni-processor system including one processor (e.g., processor 1110a), or a multi-processor system including any number of suitable processors (e.g., 1110a-1110n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1100 may include a plurality of computing devices (e.g., distributed computing systems) to implement various processing functions.

I/O device interface 1130 may provide an interface for connection of one or more I/O devices 1160 to computing system 1100. I/O devices may include devices that receive input (e.g., from a user) or output information (e.g., to a user). I/O devices 1160 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1160 may be connected to computing system 1100 through a wired or wireless connection. I/O devices 1160 may be connected to computing system 1100 from a remote location. I/O devices 1160 located on remote computing system, for example, may be connected to computing system 1100 via a network and network interface 1140.

Network interface 1140 may include a network adapter that provides for connection of computing system 1100 to a network. Network interface 1140 may facilitate data exchange between computing system 1100 and other devices connected to the network. Network interface 1140 may support wired or wireless communication. The network may include an electronic communication network, such as the Internet, a local area network (LAN), a wide area network (WAN), a cellular communications network, or the like.

System memory 1120 may be configured to store program instructions 1101 or data 1102. Program instructions 1101 may be executable by a processor (e.g., one or more of processors 1110a-1110n) to implement one or more embodiments of the present techniques. Instructions 1101 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1120 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM or DVD-ROM, hard-drives), or the like. System memory 1120 may include a non-transitory computer readable storage medium that may have program instructions stored thereon that are executable by a computer processor (e.g., one or more of processors 1110a-1110n) to cause the subject matter and the functional operations described herein. A memory (e.g., system memory 1120) may include a single memory device or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1150 may be configured to coordinate I/O traffic between processors 1110a-1110n, system memory 1120, network interface 1140, I/O devices 1160, or other peripheral devices. I/O interface 1150 may perform protocol, timing, or other data transformations to convert data signals from one component (e.g., system memory 1120) into a format suitable for use by another component (e.g., processors 1110a-1110n). I/O interface 1150 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 1100 or multiple computing systems 1100 configured to host different portions or instances of embodiments. Multiple computing systems 1100 may provide for parallel or sequential processing/execution of one or more portions of the techniques described herein.

Those skilled in the art will appreciate that computing system 1100 is merely illustrative and is not intended to limit the scope of the techniques described herein. Computing system 1100 may include any combination of devices or software that may perform or otherwise provide for the performance of the techniques described herein. For example, computing system 1100 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 1100 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computing system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 1100 may be transmitted to computing system 1100 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computing system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 5 performs part of step C and step D), unless otherwise indicated. Similarly, reference to “a computing system” performing step A and “the computing system” performing step B can include the same computing device within the computing system performing both steps or different computing devices within the computing system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:
1. A non-transitory, machine-readable medium storing instructions that, when executed by one or more processors, effectuate operations comprising: receiving, with a computer system and via a network, a request for a media choreography asset to play on a first client computing device that includes at least one of an audio system or a display system configured to output at least one of audio content or video content, respectively and the first client computing device has control over at least one connected device that has a feature that is configured to provide a sensory output to a user; obtaining, with the computer system, the media choreography asset, wherein the media choreography asset includes a primary media track that includes at least one of a first audio track to be presented via the audio system or a first video track to be presented via the display system, and the media choreography asset includes a one or more triggers that includes a first set of instructions to operate a first set of the at least one connected device at a first timecode and a first duration during a playback of the primary media track; and providing, with the computer system, the media choreography asset to the first client computing device, wherein the providing the media choreography asset to the first client computing device causes the primary media track to play via at least one the audio system or the display system and causes the first client computing device to operate the first set of the at least one connected device according to the first set of instructions at the first timecode in the primary media track.
2. The medium of embodiment 1, wherein the operations further comprise: receiving, with the computer system, sensor data from the first client computing device during the playback of the media choreography asset; determining, with the computer system and based on the sensor data, a condition exists to change the playback of at least one of the primary media track or the one or more triggers of the media choreography asset; and communicating, with the computer system, change instructions to change to the playback of at least a portion of the at least one of the primary media track or the one or more triggers that has not been played or an updated media choreography asset that deviates from the media choreography asset.
3. The medium of embodiment 2, wherein the sensor data includes at least one of a geolocation, an acceleration, or a velocity.
4. The medium of any one of embodiments 1-3, wherein the request provides an indication of a media device configuration that includes at least one of an audio system type of the audio system, a display system type of the display system, or a connected device type of the at least one connected device, and the operations further comprise: modifying, with the computer system, at least one of the primary media track or the one or more triggers of the media choreography asset to play based on the media device configuration.
5. The medium of embodiment 4, wherein the indication includes at least one of a first client computing identifier that indicates the media device configuration of the first client computing device or the media device configuration identified by the first client computing device.
6. The medium of any one of embodiments 1-5, wherein the first client computing device is a vehicle or an Internet of Things (IoT) controller.
7. The medium of any one of embodiments 1-6, wherein the operations further comprise: receiving, with the computer system and via the network, a second request for the media choreography asset to play on a second client computing device that includes at least one of a second audio system or a second display system configured to output at least one of audio content or video content, respectively and the second client computing device has control over at least one second connected device that has a feature configured to provide a sensory output to a second user, wherein the second request includes an indication of a media device configuration that includes at least one of an audio system type of the second audio system, a display system type of the second display system, or a connected device type of the at least one second connected device; obtaining, with the computer system, the media choreography asset; modifying, with the computer system and based on the media device configuration, at least one of the primary media track or the one or more triggers of the media choreography asset to play; and providing, with the computer system, a modified media choreography asset to the second client computing device, wherein the providing the media choreography asset to the second client computing device causes the primary media track to play via at least one of the second audio system or the second display system and causes the second client computing device to operate a second set of at least one second connected device according to a second set of instructions at the first timecode in the primary media track.
8. The medium of any one of embodiments 1-7, wherein the request includes location information associated with a geolocation that the first client computing device is located or will be located, and wherein the obtaining the media choreography asset from a media choreography asset database includes: determining a first set of media choreography assets from the media choreography asset database associated with the location information; and selecting the media choreography asset from the first set of media choreography assets.
9. The medium of embodiment 8, wherein the selecting of the media choreography asset is based on at least one of a user identifier associated with the first client computing device or a history of media choreography asset consumption of media choreography assets associated with the geolocation included in the location information for the first client computing device.
10. The medium of any one of embodiments 1-9, wherein the operations further comprise: receiving, by the computer system and during the playback of the media choreography asset, an indication that the playback of the media choreography asset will be transferred to a second client computing device; stopping, by the computer system, the providing of the media choreography asset to the first client computing device; and providing, by the computer system, the media choreography asset and a timecode at which the playback to the first client computing device ended to the second client computing device.
11. The medium of any one of embodiments 1-10, wherein the media choreography asset includes at least one of a secondary media track or at least one secondary trigger that is associated with a second client computing device that includes at least one of a second audio system, a second display system, or at least one second connected device, wherein the operations further comprise: providing, by the computer system, the media choreography asset to the second client computing device for the playback.
12. The medium of embodiment 11, wherein the operations further comprise: receiving, with the computer system, sensor data that includes location data of the first client computing device during the playback of the media choreography asset; and adjusting, with the computer system, the playback of the media choreography asset at the first client computing device based on the location data such that the playback of the primary media track and the one or more triggers aligns with playback of the at least one of the secondary media track or the at least one secondary trigger when the location data of the first client computing device satisfies a location condition associated with the second client computing device.
13. The medium of any one of embodiments 1-12, wherein the operations further comprise: receiving, with the computer system, sensor data that includes location data of the first client computing device during the playback of the media choreography asset; determining, with the computer system and based on the location data, that the first client computing device is approaching an area from which the first client computing device establish a satisfactory network connection with the network; and caching, with the computer system, at least a portion of the media choreography asset at the first client computing device prior to the first client computing device entering the area.
14. The medium of embodiment 13, wherein an amount of the media choreography asset cached is based on an anticipated duration of the first client computing device being located in the area or portions of the media choreography asset that are to be played at locations in the area.
15. The medium of any one of embodiments 1-14, wherein the operations further comprise: generating, by the computer system, the media choreography asset; and storing, by the computer system, the media choreography asset in a media choreography asset database.
16. The medium of any one of embodiments 1-15, wherein the obtaining the media choreography asset includes obtaining the media choreography asset from a media choreography asset database that stores a plurality media choreography assets.
17. The medium of any one of embodiments 1-16, wherein the obtaining the media choreography asset includes generating the media choreography asset with media content segments based on at least one of sensor data or user information.
18. The medium of any one of embodiments 1-17, wherein the operations further comprise steps of generating the media choreography asset.
19. The medium of any one of embodiments 1-18, wherein the client computing device includes a means for providing the sensory output other than through a display system or an audio system.
20. A process comprising: the operations of any one of embodiments 1-19.
21. A system, comprising: one or more processors; and memory storing instructions that when executed by the processors cause the processors to effectuate operations comprising: the operations of any one of embodiments 1-19.

What is claimed is:

1. A non-transitory, machine-readable medium storing instructions that, when executed by one or more processors, effectuate operations comprising:
receiving, with a computer system and via a network, a request for a media choreography asset to play on a first client computing device that includes at least one of an audio system or a display system configured to output at least one of audio content or video content, respectively and the first client computing device has control over at least one connected device that has a feature that is configured to provide a sensory output to a user;
obtaining, with the computer system, the media choreography asset, wherein the media choreography asset includes a primary media track that includes at least one of a first audio track to be presented via the audio system or a first video track to be presented via the display system, and the media choreography asset includes a one or more triggers that includes a first set of instructions to operate a first set of the at least one connected device at a first timecode and a first duration during a playback of the primary media track; and
providing, with the computer system, the media choreography asset to the first client computing device, wherein the providing the media choreography asset to the first client computing device causes the primary media track to play via at least one the audio system or the display system and causes the first client computing device to operate the first set of the at least one connected device according to the first set of instructions at the first timecode in the primary media track.

2. The medium of claim 1, wherein the operations further comprise:
receiving, with the computer system, sensor data from the first client computing device during the playback of the media choreography asset;
determining, with the computer system and based on the sensor data, a condition exists to change the playback of at least one of the primary media track or the one or more triggers of the media choreography asset; and
communicating, with the computer system, change instructions to change to the playback of at least a portion of the at least one of the primary media track or the one or more triggers that has not been played or an updated media choreography asset that deviates from the media choreography asset.

3. The medium of claim 2, wherein the sensor data includes at least one of a geolocation, an acceleration, or a velocity.

4. The medium of claim 1, wherein the request provides an indication of a media device configuration that includes at least one of an audio system type of the audio system, a display system type of the display system, or a connected device type of the at least one connected device, and the operations further comprise:
modifying, with the computer system, at least one of the primary media track or the one or more triggers of the media choreography asset to play based on the media device configuration.

5. The medium of claim 4, wherein the indication includes at least one of a first client computing identifier that indicates the media device configuration of the first client computing device or the media device configuration identified by the first client computing device.

6. The medium of claim 1, wherein the first client computing device is a vehicle or an Internet of Things (IoT) controller.

7. The medium of claim 1, wherein the operations further comprise:
receiving, with the computer system and via the network, a second request for the media choreography asset to play on a second client computing device that includes at least one of a second audio system or a second display system configured to output at least one of audio content or video content, respectively and the second client computing device has control over at least one second connected device that has a feature configured to provide a sensory output to a second user, wherein the second request includes an indication of a media device configuration that includes at least one of an audio system type of the second audio system, a display system type of the second display system, or a connected device type of the at least one second connected device;
obtaining, with the computer system, the media choreography asset;
modifying, with the computer system and based on the media device configuration, at least one of the primary media track or the one or more triggers of the media choreography asset to play; and
providing, with the computer system, a modified media choreography asset to the second client computing device, wherein the providing the media choreography asset to the second client computing device causes the primary media track to play via at least one of the second audio system or the second display system and causes the second client computing device to operate a second set of at least one second connected device according to a second set of instructions at the first timecode in the primary media track.

8. The medium of claim 1, wherein the request includes location information associated with a geolocation that the first client computing device is located or will be located, and wherein the obtaining the media choreography asset from a media choreography asset database includes:
determining a first set of media choreography assets from the media choreography asset database associated with the location information; and
selecting the media choreography asset from the first set of media choreography assets.

9. The medium of claim 8, wherein the selecting of the media choreography asset is based on at least one of a user identifier associated with the first client computing device or a history of media choreography asset consumption of media choreography assets associated with the geolocation included in the location information for the first client computing device.

10. The medium of claim 1, wherein the operations further comprise:
receiving, by the computer system and during the playback of the media choreography asset, an indication that the playback of the media choreography asset will be transferred to a second client computing device;
stopping, by the computer system, the providing of the media choreography asset to the first client computing device; and
providing, by the computer system, the media choreography asset and a timecode at which the playback to the first client computing device ended to the second client computing device.

11. The medium of claim 1, wherein the media choreography asset includes at least one of a secondary media track or at least one secondary trigger that is associated with a second client computing device that includes at least one of a second audio system, a second display system, or at least one second connected device, wherein the operations further comprise:
providing, by the computer system, the media choreography asset to the second client computing device for the playback.

12. The medium of claim 11, wherein the operations further comprise:
receiving, with the computer system, sensor data that includes location data of the first client computing device during the playback of the media choreography asset; and
adjusting, with the computer system, the playback of the media choreography asset at the first client computing device based on the location data such that the playback of the primary media track and the one or more triggers aligns with playback of the at least one of the secondary media track or the at least one secondary trigger when the location data of the first client computing device satisfies a location condition associated with the second client computing device.

13. The medium of claim 1, wherein the operations further comprise:
receiving, with the computer system, sensor data that includes location data of the first client computing device during the playback of the media choreography asset;
determining, with the computer system and based on the location data, that the first client computing device is approaching an area from which the first client computing device establish a satisfactory network connection with the network; and
caching, with the computer system, at least a portion of the media choreography asset at the first client computing device prior to the first client computing device entering the area.

14. The medium of claim 13, wherein an amount of the media choreography asset cached is based on an anticipated duration of the first client computing device being located in the area or portions of the media choreography asset that are to be played at locations in the area.

15. The medium of claim 1, wherein the operations further comprise:
generating, by the computer system, the media choreography asset; and
storing, by the computer system, the media choreography asset in a media choreography asset database.

16. The medium of claim 1, wherein the obtaining the media choreography asset includes obtaining the media choreography asset from a media choreography asset database that stores a plurality media choreography assets.

17. The medium of claim 1, wherein the obtaining the media choreography asset includes generating the media choreography asset with media content segments based on at least one of sensor data or user information.

18. The medium of claim 1, wherein the operations further comprise steps of generating the media choreography asset.

19. The medium of claim 1, wherein the client computing device includes a means for providing the sensory output other than through a display system or an audio system.

20. A method, comprising:
receiving, with a computer system and via a network, a request for a media choreography asset to play on a first client computing device that includes at least one of an audio system or a display system configured to output at least one of audio content or video content, respectively and the first client computing device has control over at least one connected device that has a feature configured to provide a sensory output to a user;
obtaining, with the computer system, the media choreography asset, wherein the media choreography asset includes a primary media track that includes at least one of a first audio track to be presented via the audio system or a first video track to be presented via the display system, and the media choreography asset includes a one or more triggers that includes a first set of instructions to operate a first set of the at least one connected device at a first timecode and a first duration during a playback of the primary media track; and
providing, with the computer system, the media choreography asset to the first client computing device, wherein the providing the media choreography asset to the first client computing device causes the primary media track to play via at least one the audio system or the display system and causes the first client computing device to operate the first set of the at least one connected device according to the first set of instructions at the first timecode in the primary media track.
